(19) United States
(12) Patent Application Publication
(10) Pub. No.: US 2026/0362129 A1
(43) Pub. Date: Nov. 12, 2026

(54) Inter-CU Lower Layer-Triggered Mobility Execution

(71) Applicant: Telefonaktiebolaget LM Ericsson (publ), Stockholm (SE)

(72) Inventors: Pontus Wallentin, Linköping (SE); Icaro Leonardo Da Silva, Solna (SE); Antonino Orsino, Kirkkonummi (FI); Liwei Qiu, Täby (SE); Ioanna Pappa, Stockholm (SE); Jens Bergqvist, Linköping (SE)

(21) Appl. No.: 19/487,074

(22) PCT Filed: May 30, 2024
(86) PCT No.: PCT/SE2024/050538

§ 371 Date: Nov. 24, 2025

Related U.S. Application Data
(60) Provisional application No. 63/469,630, filed on May 30, 2023.

(51) Int. Cl. H04W 12/041; H04W 12/0433; H04W 36/00; H04W 36/38

(52) U.S. Cl. CPC H04W 12/041; H04W 12/0433; H04W 36/0038; H04W 36/38

(57) ABSTRACT

A method is performed by a user equipment. The method comprises receiving (302), from a network node, a configuration for use in connecting to and/or communicating with a candidate cell following a lower-layer cell mobility procedure. The lower-layer cell mobility procedure comprises a cell switch from a source cell served by a first base station or a first centralized unit, CU, to a candidate cell served by a second base station or a second CU. The configuration comprises at least a first part of information that enables the user equipment to refresh one or more security keys for use in connecting to and/or communicating with the candidate cell.

### TECHNICAL FIELD

Embodiments of the present disclosure relate to communications networks, and particularly to inter-CU Lower Layer-Triggered Mobility (LTM) execution.

### BACKGROUND

### Layer 1 (L1)/Layer 2 (L2) Based Inter-Cell Mobility in Release 18 (Rel-18)

In 3rd Generation Partnership Project (3GPP) Release 18, a work item known as Further New Radio (NR) mobility enhancements is ongoing. This work item includes a technical area entitled L1/L2 based inter-cell mobility. According to the MediaTek Inc and Apple Work Item Description (WID) entitled “Further NR mobility enhancements” (RP-223520), when the User Equipment (UE) moves from the coverage area of one cell to another cell, at some point a serving cell change needs to be performed. Currently serving cell change is triggered by Layer 3 (L3) measurements and is done by Radio Resource Control (RRC) signalling triggered Reconfiguration with Synchronisation for change of Primary Cell (PCell) and Primary Secondary Cell (PSCell), as well as release/add for Secondary Cells (SCells) when applicable. All cases involve complete L2 (and L1) resets, leading to longer latency, larger overhead and longer interruption time than beam switch mobility. The goal of L1/L2 based inter-cell mobility is to enable a serving cell change via L1/L2 signalling, in order to reduce the latency, overhead and interruption time.

According to the WID, the following is included as one objective of the work:
To specify mechanism and procedures of L1/L2 based inter-cell mobility for mobility latency reduction:
   Configuration and maintenance for multiple candidate cells to allow fast application of configurations for candidate cells [RAN2, RAN3]
   Dynamic switch mechanism among candidate serving cells (including SpCell and SCell) for the potential applicable scenarios based on L1/L2 signalling [RAN2, RAN1]
   L1 enhancements for inter-cell beam management, including L1 measurement and reporting, and beam indication [RAN1, RAN2]
      Note 1: Early RAN2 involvement is necessary, including the possibility of further clarifying the interaction between this bullet with the previous bullet
   Timing Advance management [RAN1, RAN2]
   Central Unit (CU)-Distributed Unit (DU) interface signaling to support L1/L2 mobility, if needed [RAN3]
Note 2: Frequency Range 2 (FR2) specific enhancements are not precluded, if any.
Note 3: The procedure of L1/L2 based inter-cell mobility are applicable to the following scenarios:
   Standalone, Carrier Aggregation (CA) and NR-Carrier Aggregation (DC) case with serving cell change within one Cell Group (CG)
   Intra-DU case and intra-CU inter-DU case (applicable for Standalone and CA: no new RAN interfaces are expected)
   Both intra-frequency and inter-frequency
   Both Frequency Range 1 (FR1) and FR2
   Source and target cells may be synchronized or non-synchronized

In 3GPP, discussions have started on solutions for L1/L2 based inter-cell mobility (sometimes also referred to as “LTM”, “L1/L2-triggered mobility” or “lower layer-triggered mobility”).

A basic principle with L1/L2-triggered mobility is that the UE is pre-configured, by the network, with an RRC configuration per LTM candidate cell, sometimes also known as a LTM candidate cell configuration. Such a LTM candidate cell configuration may be an RRCReconfiguration message or one or more Information Elements (IEs)/fields/parameters such as CellGroupConfig. The UE performs measurements on these LTM candidate cells and transmits corresponding measurement reports to the network. The network then triggers the execution of a LTM cell switch procedure in the UE to one of these LTM candidate cells by transmitting lower layer signaling in a Medium Access Control (MAC) Control Element (CE), sometimes also referred to as a “LTM cell switch command”, to the UE, which then connects to the particular LTM candidate cell and switches to the LTM candidate cell configuration. RAN2 has also agreed the following for L1/L2-triggered mobility in Rel-18:
RAN2 to use “LTM” as term for the L1/L2-triggered mobility.
Use the term “cell switch” for the procedure of triggering change of cells via the LTM feature
Use the term “Subsequent” LTM for the case when cell switch between L1/L2 mobility candidates is done without RRC reconfiguration in between.
No security update support in Rel-18 with L1/L2 based mobility.
RAN2 to confirm that the CellGroupConfig IE is (mandatory) needed within an LTM candidate cell configuration.
The RadioBearerConfig IE can be optionally supported in an LTM candidate configuration
The MeasConfig IE can be optionally supported in an LTM candidate configuration.
The OtherConfig IE is not required to be part of the LTM candidate cell configuration.
The LTM candidate cell configuration should be designed as a To AddMod/ToRelease structure.
The LTM candidate cell configuration Abstract Syntax Notation (ASN.1) structure comprises at least a CellGroupConfig IE and a configuration Identifier (ID).

### On Delta Configuration

A UE stores the reference configuration as a separate configuration.
The reference configuration is managed separately.
agree to use Model 1: One RRCReconfiguration message for each candidate target configuration RRCReconfiguration to configure target candidate cells

Further, RAN3 has agreed for L1/L2-triggered mobility in Rel-18:
For inter-DU case, the target NR base station (gNB) DU indicates the gNB-CU about the UE successful access to the target cell by Access Success message.
Intra-CU User Plane (UP) case: CU will start data transmission after LTM cells switch signaling from DU including target cell ID.

### L3 Mobility in RRC_CONNECTED in Long-Term Evolution (LTE) and NR

An RRC_CONNECTED UE in LTE (also called “EUTRA”) can be configured by the network to perform measurements and, upon triggering measurement reports, the network may send a handover command to the UE (in LTE an RRConnectionReconfiguration with a field called mobilityControlInfo and in NR an RRCReconfiguration with a reconfigurationWithSync field).

These reconfigurations are prepared by the target cell upon a request from the source node (over an X2 interface in the case of EUTRA-Evolved Packet Core (EPC) or an Xn interface in the case of EUTRA-5G Core Network (5GC) or NR) and takes into account the existing RRC configuration the UE has with the source cell (which are provided in the inter-node request). Among other parameters that reconfiguration provided by the target cell contains all the information the UE needs to access the target cell, e.g., random access configuration, a new Cell Radio Network Temporary Identifier (C-RNTI) assigned by the target cell and security parameters enabling the UE to calculate new security keys associated to the target cell so the UE can send a handover complete message on Signaling Radio Bearer 1 (SRB1) (encrypted and integrity protected) based on new security keys upon accessing the target cell.

FIG. 1 summarizes the signalling flow between UE 102, source node 104 and target node 106 during a layer 3 handover procedure, as also described in 3GPP Technical Specification (TS) 38.300 v17.4.0.

The main steps during an inter-gNB handover procedure are as follows (referring to FIG. 1):
Step 108: The source gNB 104 initiates handover and issues a HANDOVER REQUEST over the Xn interface.
Step 110 and 112: The target gNB 106 performs admission control and provides the new RRC configuration as part of the HANDOVER REQUEST ACKNOWLEDGE.
Step 114: The source gNB 104 provides the RRC configuration to the UE 102 by forwarding the RRCReconfiguration message received in the HANDOVER REQUEST ACKNOWLEDGE. The RRCReconfiguration message includes at least cell ID and all information required to access the target cell so that the UE 102 can access the target cell without reading system information. In some cases, the information required for contention-based and contention-free random access can be included in the RRCReconfiguration message. The access information to the target cell may include beam specific information, if any.
Step 116 and 118: The UE 102 moves the RRC connection to the target gNB 106 and replies with the RRCReconfigurationComplete.

### SUMMARY

There currently exist certain challenge(s).

As can be read in the above discussed 3GPP Rel-18 Work Item Description (WID) for Further NR Mobility Enhancements, it is limited to “Intra-DU case and intra-CU inter-DU case”, where DU and CU refers to the Distributed Unit and Central Unit in a distributed CU/DU RAN architecture. This means that in Rel-18, L1/L2-triggered mobility is limited to intra-CU cases. Thus, for mobility between gNBs/CUs, LTM cannot be used.

FIG. 2 shows the signaling flow between a UE 202, a gNB-DU 204, and a gNB-CU 206, for the intra-CU inter-DU case, to be captured in 3GPP TS 38.401. The steps of FIG. 2 are as follows:
At step 208, user data is exchanged between the UE 202 and the gNB-DU 204, and between the gNB-DU 204 and the gNB-CU 206.
At step 210, an L3 measurement control and reports procedure is performed between the UE 202, the gNB-DU 204, and the gNB-CU 206.
At step 212, an LTM configuration decision is made at the gNB-CU 206.
At step 214, the gNB-CU 206 transmits, to the gNB-DU 204, a UE CONTEXT MODIFICATION REQUEST message.
At step 216, the gNB-DU 204 transmits, to the gNB-CU 206, a UE CONTEXT MODIFICATION RESPONSE message.
At step 218, the gNB-CU 206 transmits, to the gNB-DU 204, a Downlink (DL) RRC MESSAGE TRANSFER message (including an RRCReconfiguration message).
At step 220, the gNB-DU 204 transmits, to the UE 202, an RRCReconfiguration message.
At step 222, the UE 202 transmits, to the gNB-DU 204, an RRCReconfigurationComplete message.
At step 224, the gNB-DU 204 transmits, to the gNB-CU 206, an Uplink (UL) RRC MESSAGE TRANSFER message (including an RRCReconfigurationComplete message).
At step 226, the UE 202 transmits, to the gNB-DU 204, a lower layer measurement report.
At step 228, the gNB-DU 204 makes an inter-cell mobility execution decision.
At step 230, the gNB-DU 204 transmits, to the UE 202, an LTM command.
At step 232, the gNB-DU 204 transmits, to the gNB-CU 206, LTM signalling (including a Target Cell ID).
At step 234, the gNB-DU 204 transmits, to the gNB-CU 206, a DL data delivery status.
At step 236, the gNB-DU 204 detects the UE 202 access. The details of this step are for future study.
At step 238, the gNB-DU 204 transmits, to the gNB-CU 206, an ACCESS SUCCESS message (including a Target Cell ID).
At step 240, the gNB-CU 206 transmits, to the gNB-DU 204, a UE CONTEXT MODIFICATION REQUEST message (including prepared cells to be released).
At step 242, the gNB-DU 204 transmits, to the gNB-CU 206, a UE CONTEXT MODIFICATION RESPONSE message.
At step 244, user data is exchanged between the UE 202 and the gNB-DU 204, and between the gNB-DU 204 and gNB-CU 206.

A possible evolution of LTM is to extend it to cover also inter-CU/inter-gNB mobility. As part of such an evolution, one problem is to make the LTM cell switch procedure support also inter-CU mobility. From the illustration in FIG. 2 of the intra-CU/inter-DU LTM cell switch procedure, it is not clear how an inter-CU (inter-gNB) LTM cell switch procedure could be supported.

The L3 handover procedure (also known as reconfiguration with sync for NR) supports inter-gNB mobility. However, the handover procedure is very different from L1/L2-triggered mobility as it is based on the network receiving L3 measurement reports and transmitting an L3 handover command (such as an RRCReconfiguration message) to trigger the execution of the handover in the UE. The inter-node signalling between source and target gNBs during L3 handover is used to reserve resources in the target gNB and to prepare the handover command message which is sent to the UE by the source gNB. This inter-node signalling cannot be used during an LTM cell switch procedure, for which the RRCReconfiguration message has already been sent to the UE during LTM configuration and not during execution.

Certain aspects of the disclosure and their embodiments may provide solutions to these or other challenges.

In a first aspect of the disclosure, there is provided a method performed by a user equipment. The method comprises receiving, from a network node, a configuration for use in connecting to and/or communicating with a candidate cell following a lower-layer cell mobility procedure, wherein the lower-layer cell mobility procedure comprises a cell switch from a source cell served by a first base station or a first centralized unit, CU, to a candidate cell served by a second base station or a second CU. The configuration comprises at least a first part of information that enables the user equipment to refresh one or more security keys for use in connecting to and/or communicating with the candidate cell.

In a second aspect of the disclosure, there is provided a method performed by a network node. The method comprises transmitting, to a user equipment, a configuration for use in connecting to and/or communicating with a candidate cell following a lower-layer cell mobility procedure. The configuration comprises a first part of information that enables the user equipment to refresh one or more security keys for use in connecting to and/or communicating with the candidate cell.

In a third aspect of the disclosure, there is provided a method performed by a second network node. The method comprises receiving, from a user equipment, a message comprising an indication that a lower-layer cell mobility procedure from a first network node is complete.

In a fourth aspect of the disclosure, there is provided a method performed by a core network node. The method comprises receiving, from a source network node or a target network node, an indication of a lower-layer cell mobility procedure for a user equipment from the source network node to the target network node, wherein the source network node and the target network node comprise different base stations or different centralized units

In a fifth aspect of the disclosure, there is provided a user equipment. The user equipment comprises processing circuitry configured to cause the user equipment to perform the method of any embodiment of the first aspect.

In a sixth aspect of the disclosure, there is provided a network node. The network node comprises processing circuitry configured to cause the network node to perform the method of any embodiment of the second aspect.

In a seventh aspect of the disclosure, there is provided a second network node. The second network node comprises processing circuitry configured to cause the second network node to perform the method of any embodiment of the third aspect.

In an eight aspect of the disclosure, there is provided a core network node. The core network node comprises processing circuitry configured to cause the core network node to perform the method of any embodiment of the fourth aspect.

In order to address the above challenges, embodiments of the present disclosure provide solutions to perform execution of an inter-CU L1/L2-triggered mobility cell switch procedure from a source cell, controlled by a source network node (such as a source gNB), to a target cell, controlled by a target network node (such as a target gNB).

During this inter-CU LTM cell switch procedure, the UE may apply an inter-CU LTM candidate cell configuration and/or perform a security key refresh to generate a new set of ciphering and integrity protection keys to be used in the target cell. The UE may also transmit, to the target network node, an LTM cell switch complete message that indicates execution of an inter-CU LTM cell switch procedure. This LTM cell switch complete message may be ciphered and integrity protected with the newly generated set of keys.

Embodiments of the present disclosure provide techniques performed by a source network node and a target network node during the execution of an inter-CU LTM cell switch procedure, including the signalling between those nodes.

Embodiments of the present disclosure also describe the handling of security keys at subsequent LTM.

Certain embodiments may provide one or more of the following technical advantage(s). The methods disclosed herein enable a lower-layer cell mobility procedure to take place in which the lower-layer cell mobility procedure comprises a cell switch from a source cell served by a first base station or a first centralized unit, CU, to a candidate cell served by a second base station or a second CU.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 shows a L3 handover procedure;

FIG. 2 shows a signaling flow for LTM in intra-CU/inter-DU;

FIG. 3 shows a system structure according to some embodiments;

FIG. 4 shows a method performed by a user equipment according to embodiments of the disclosure;

FIG. 5 shows a method performed by a network node according to embodiments of the disclosure;

FIG. 6 shows a method performed by a second network node according to embodiments of the disclosure;

FIG. 7 shows a method performed by a core network entity according to embodiments of the disclosure;

FIG. 8 shows a message sequence chart according to some embodiments;

FIG. 9 shows a message sequence chart according to some embodiments;

FIG. 10 shows a message sequence chart according to some embodiments;

FIG. 11 shows a message sequence chart according to some embodiments;

FIG. 12 is a flow chart showing a method performed by a UE according to some embodiments;

FIG. 13 is a signaling diagram illustrating a handover preparation procedure;

FIG. 14 is a signaling diagram illustrating an unsuccessful operation in a handover preparation procedure;

FIG. 15 shows an example of a communication system in accordance with some embodiments;

FIG. 16 shows a UE in accordance with some embodiments;

FIG. 17 shows a network node in accordance with some embodiments;

FIG. 18 is a block diagram of a host in accordance with various aspects described herein;

FIG. 19 is a block diagram illustrating a virtualization environment in which

functions implemented by some embodiments may be virtualized;

FIG. 20 shows a communication diagram of a host communicating via a network node with a UE over a partially wireless connection in accordance with some embodiments; and

FIG. 21 shows a network node in accordance with further embodiments.

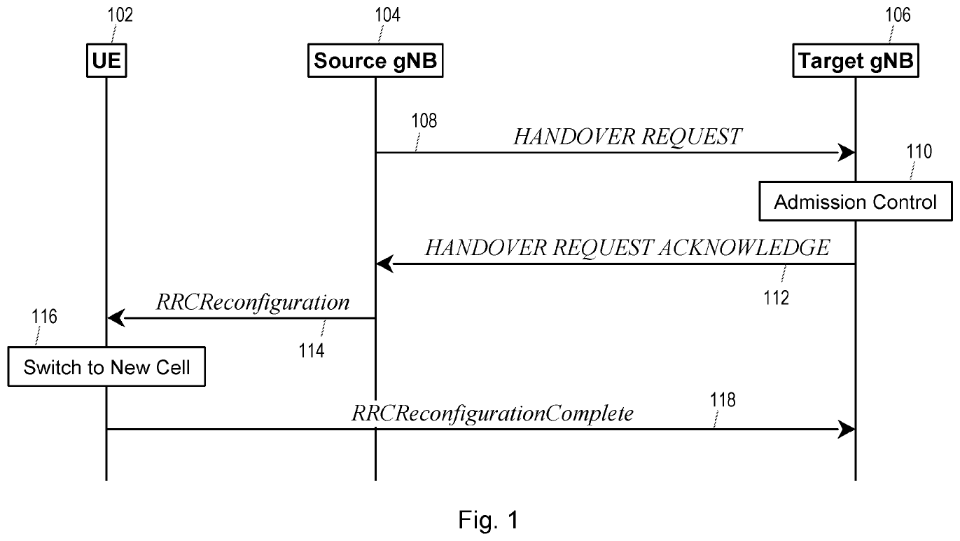

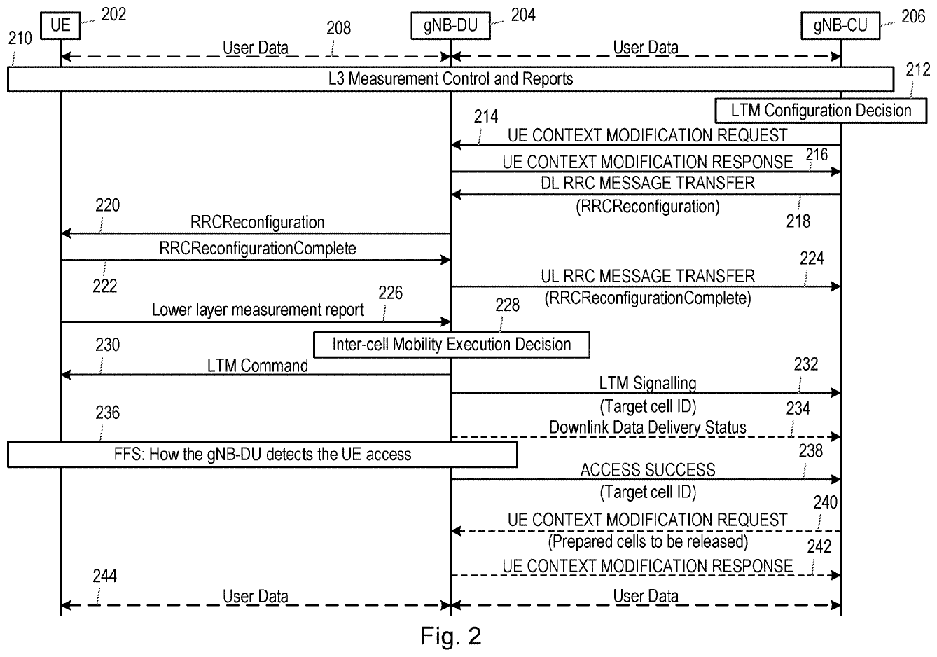

### DETAILED DESCRIPTION

Some of the embodiments contemplated herein will now be described more fully with reference to the accompanying drawings. Embodiments are provided by way of example to convey the scope of the subject matter to those skilled in the art.

The present disclosure refers to the term “L1/L2 based inter-cell mobility” as used in the Work Item Description in 3GPP, though it interchangeably also uses the terms L1/L2 mobility, L1-mobility, L1 based mobility, L1/L2-centric inter-cell mobility, L1/L2 inter-cell mobility L1/L2-Triggered Mobility, Lower-layer triggered Mobility or LTM. The basic principle is that the UE normally receives a lower layer signaling from the network indicating to the UE a change (or switch or activation) of its serving cell (e.g. change of PCell, from a source to a target Pcell), wherein a lower layer signaling is a message/signaling of a lower layer protocol, which sometimes may be referred as a L1/L2 inter-cell mobility execution command or LTM cell switch command. The change of serving cell (e.g. change of Pcell) may also lead to a change in Scell(s) for the same cell group e.g. in case the command triggers the UE to change to another cell group configuration of the same type (e.g. another MCG configuration). Before the UE receives the LTM cell switch command, the UE is configured by the network with one or more LTM candidate cell configurations (e.g. reception of an RRC Reconfiguration message, with at least one LTM candidate cell configuration) A LTM candidate cell configuration may include parameters in the IE CellGroupConfig for an LTM candidate cell and/or an embedded RRC Reconfiguration for an LTM candidate cell.

The term LTM cell switch procedure refers to the process of a UE switching (or changing) its cell from a source cell to a target cell (which may be called here an LTM candidate cell or a neighbour cell), using L1/L2-triggered mobility (LTM). In the context of L1/L2-triggered mobility (LTM), an LTM cell switch procedure may sometimes also be known as L1/L2 based inter-cell mobility execution, LTM execution, dynamic switch, LTM switch, (LTM) cell switch, (LTM) serving cell change or (LTM) cell change. In the context of the present disclosure, switching to the LTM candidate cell configuration comprises the UE considering that an LTM candidate cell becomes its new special cell (SpCell) e.g. Pcell in case of LTM being configured for a Master Cell Group (MCG) and/or PSCell in case of LTM being configured for a Secondary Cell Group (SCG); or, changing its SpCell from the current Pcell to an LTM candidate cell.

Even if the term switch or change of cells is used, that may comprise a switch or change of a whole cell group configuration, which includes a change in the SpCell (e.g. change of Pcell, or change of PSCell) and a change in Scells of the cell group (e.g. addition, modification and/or release of one or more Scells).

An LTM cell switch procedure may be triggered in the UE by reception of a LTM cell switch command, or alternatively, triggered by some other event, such as a condition, e,g, a triggering condition used for conditional configuration, such as conditional handover, being fulfilled, as a result of recovery from radio link failure or handover failure.

The text refers to an inter-CU LTM cell switch procedure, which is an LTM cell switch procedure resulting in a change of serving cell, e.g. change of SpCell, Pcell, PSCell, to an LTM candidate cell controlled by a different gNB than the source gNB or serving gNB of the UE upon reception of the LTM cell switch command. From UE point of view, the actions performed during an inter-CU LTM cell switch procedure may be the same type of actions of an LTM cell switch procedure, but may also include additional actions, such as change of security key(s).

The text refers to a LTM candidate cell, which is a cell the UE is configured with when configured with L1/L2-triggered mobility. That is a cell the UE can move to in an LTM cell switch procedure. Such cells may also be called candidate cell(s), candidates, mobility candidates, non-serving cells, additional cells, target candidate cell, target candidate, etc. A LTM candidate cell is a cell the UE may perform measurements on (e.g. CSI measurements) so that the UE reports these measurements and network may take educated decision on which beam (e.g. TCI state) and/or cell the UE is to be switched to. An LTM candidate cell may be a candidate to be a target Pcell or PSCell, or an Scell of a cell group (e.g. MCG Scell or a SCG Scell).

The present disclosure refers to at least one LTM candidate cell configuration and that the UE has received at least one LTM candidate cell configuration. This is also sometimes referred to as a configuration of a LTM candidate cell, which may be an RRC configuration, such as encapsulated in an RRC Reconfiguration message, that the UE receives when being configured with L1/L2-Triggered Mobility. A LTM candidate cell configuration comprises the configuration which the UE needs to start to operate accordingly when it performs an LTM cell switch procedure to that LTM candidate cell e.g. upon reception of the LTM cell switch command indicating the UE to perform a LTM cell switch procedure to that LTM candidate cell, which becomes the target cell and the current (new) SpCell, or an Scell in a serving frequency. The LTM candidate cell configuration comprises parameters of a serving cell (or multiple serving cells, such as a cell group), comprising one or more of the groups of parameters, such as an RRCReconfiguration message an IE CellGroupConfig or an IE SpCellConfig (or the IE ScellConfig, in the case of a Secondary Cell). A LTM candidate cell configuration may in one example comprise one or more of: i) the Pcell configuration and one or more Scell configuration(s) of a Master Cell Group (MCG); i) the PSCell configuration and one or more Scell configuration(s) of a secondary Cell Group (SCG). The terms (LTM) candidate configuration, LTM configuration, (LTM) candidate target cell configuration, (LTM) target candidate (cell) configuration may be used interchangeably when referring to LTM candidate cell configuration. An LTM candidate cell configuration is associated with an identifier which is used in the signaling when referring to a certain LTM candidate cell configuration, such as when the UE receives the LTM candidate cell configuration and when the UE receives an LTM cell switch command indicating the UE to perform a LTM cell switch procedure to that LTM candidate cell. This identifier is sometimes known as the LTM candidate cell configuration identity or LTM candidate configuration index (or similar).

The actual LTM candidate cell configuration and its exact content and/or structure of this IE and/or embedded message may be called an RRC model for the candidate configuration, or simply RRC model. An LTM candidate cell configuration comprises the configuration which the UE needs to operate accordingly when it performs (executes) L1/L2 based inter-cell mobility execution to a LTM candidate cell, upon reception of the lower layer signaling (MAC CE) indicating a L1/L2 based inter-cell mobility to a LTM candidate cell (which becomes the target cell and the current (new) Pcell, or an Scell in a serving frequency), or upon reception of the lower layer signaling (MAC CE) indicating a L1/L2 based inter-cell mobility to an LTM candidate cell configuration indicated with a candidate configuration index (sometimes also denoted candidate configuration ID). The UE may be configured with multiple LTM candidate cell configurations, so a Candidate DU generates and sends to the CU multiple configuration(s). The actual LTM candidate cell configuration the UE receives during the LTM configuration may be a delta signaling to be applied on top of a reference configuration, so that the actual configuration the UE is to use in the candidate cell upon LTM cell switch is the combination of the LTM candidate cell configuration and the reference configuration (e.g. separately signaled by the network to the UE).

The present disclosure refers to an inter-CU LTM candidate cell configuration. An inter-CU LTM candidate cell configuration is a LTM candidate cell configuration which contains the configuration which the UE needs to start to operate accordingly when it performs an LTM cell switch procedure to an LTM candidate cell which is controlled by a different base station, e.g. gNB, from the current source base station e.g. serving gNB of the UE. An inter-CU LTM candidate cell configuration may be the same as an LTM candidate cell configuration but it may also include additional information than what is included in the LTM candidate cell configuration used for inter-CU cell switch. This additional information may be, for example:
Information to perform security key refresh, e.g. the RRC IE MasterKey Update or a RRC IE RadioBearerConfig that includes Security Config with Security AlgorithmConfig.
Indication to perform a full configuration, e.g. the RRC field fullConfig.

The term “security key refresh” refers to that the UE changes its security key, e.g. during a mobility procedure such as an inter-CU LTM cell switch procedure. A security key refresh may comprise at least one of:
The UE receives a Master Key Update parameter/IE (e.g. masterKeyUpdate) included in the inter-CU LTM candidate cell configuration (e.g. set by the Target CU).
When a Non-Access Stratum (NAS) indication (e.g. nas-Container) is received (e.g. within the Master Key Update parameter/IE) the UE forwards the NAS indication to the upper layer (e.g. UE NAS layer);
When a key set change indication (e.g. keySetChangeIndicator) is received and/or is set to ‘true’ (e.g. within the Master Key Update parameter/IE) the UE derives or updates the K_{gNB} key based on the K_{AMF} key, as specified in TS 33.501;
The UE derives or updates the K_{gNB} key (for the inter-CU LTM candidate cell configuration indicated in the LTM cell switch command) based on the current K_{gNB} key or the next hop (NH), using the Next Hop Chaining Count (e.g. nextHopChainingCount) value indicated in the received Master Key Update parameter/IE (e.g. MasterKeyUpdate), as specified in TS 33.501;
The UE derives the K_{RRCenc} and K_{UPene} keys associated with a ciphering algorithm (e.g. cipheringAlgorithm indicated in the securityAlgorithmConfig), as specified in TS 33.501;
The UE derives the K_{RRCint} and K_{UPint} keys associated with an integrity protection algorithm (e.g. integrityProtAlgorithm indicated in the securityAlgorithmConfig), as specified in TS 33.501;
The UE receives a security algorithm configuration included in the inter-CU LTM candidate cell configuration, based on which the UE derives User plane keys and/or control plane keys (e.g. for encryption and/or integrity protection) e.g. the K_{RRCenc} and K_{UPenc} keys, the K_{RRCint} and K_{UPint} keys.
The UE uses its current security algorithm configuration, based on which the UE derives User plane keys and/or control plane keys (e.g. for encryption and/or integrity protection) e.g. the K_{RRCenc} and K_{UPenc} keys, the K_{RRCint} and K_{UPint} keys.
The UE applies the provided ciphering algorithm and key during an PDCP entity re-establishment procedure;
The UE applies the provided integrity protection algorithm and key during an PDCP entity re-establishment procedure

The term “subsequent LTM”, sometimes also referred to a “subsequent LTM cell switch (procedures)” refers to that the UE performs a first LTM cell switch procedure from a source cell to a first target cell, then performs a second LTM cell switch procedure from the first target cell (which is now the new source cell) to a second target cell, and between the first and second LTM cell switch procedures there is no RRC reconfiguration of the UE. This implies also that the network does not add/remove/modify the LTM candidate cell configuration(s) between the two LTM cell switch procedures. The term “beam” may correspond to a spatial direction in which a signal is transmitted (e.g. by a network node) or received (e.g. by the UE), or a spatial filter applied to a signal which is transmitted or received. Thus, transmitting signals different beams could correspond to transmitting signals in different spatial directions. When the text refers to a “beam which is selected” it may refer to a beam index and/or a Reference Signal (RS) index or identifier, such as a Synchronization Signal block (SSB) index, or a CSI-RS resource identifier. Thus, selecting a beam may correspond to selecting an SSB, associated to an SSB index. Or, selecting a beam may correspond to selecting a CSI-RS, associated to a CSI-RS resource identifier.

The text refers to dynamic information, sometimes also known as state information. Dynamic information may be included in the LTM cell switch command or in separate lower layer signaling sent together with the LTM cell switch command and may correspond to one or more indications of:
Beam indication
SCell activation/deactivation indication(s)
CSI measurement configuration activation/deactivation indication(s)
TCI state(s) indication(s)
Spatial relation indication
RS indication
UL grant
PUCCH configuration
SCG state.
PRACH configuration to be used e.g. PRACH preamble, preamble set, preamble group out of a set in the RRC configuration;
DL BWP ID
UL BWP ID
C-RNTI out of a set
Timer value
Timing advance information
Any dynamic information which may need to be activated
Any information to change state.

### System Overview

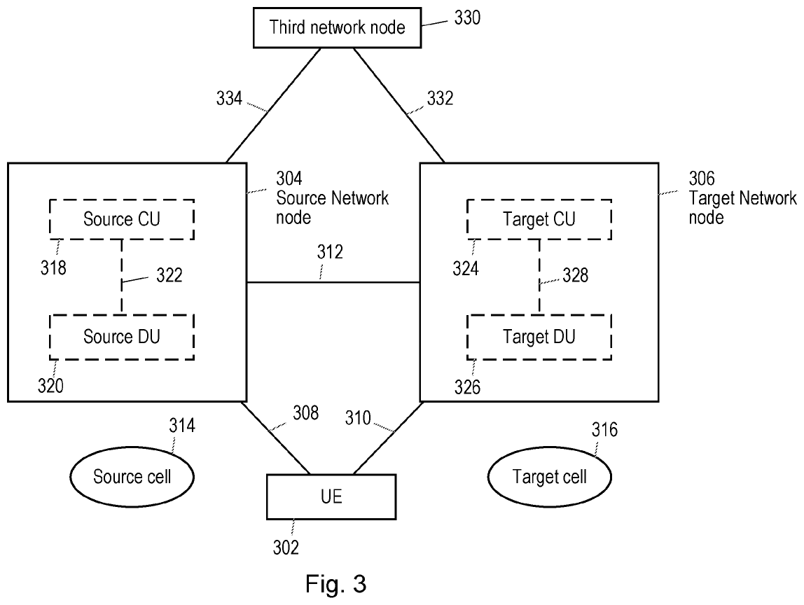

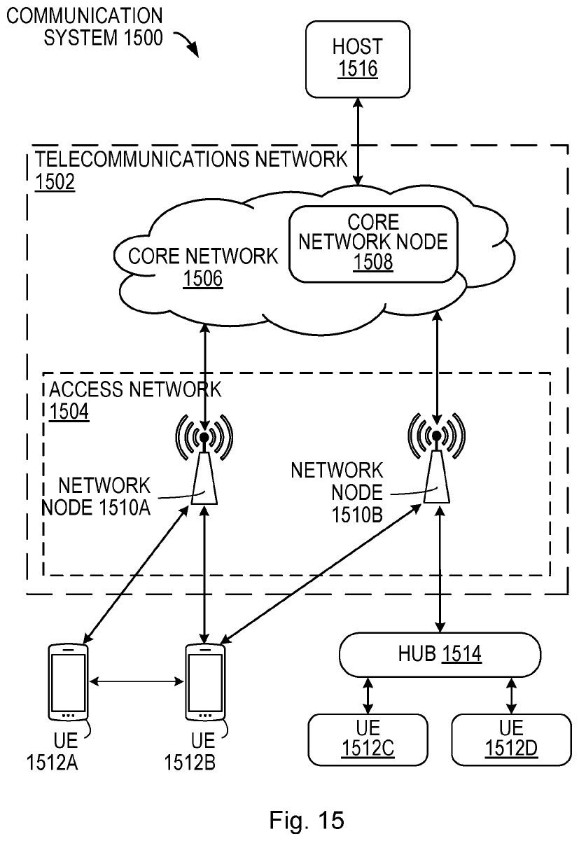

FIG. 3 illustrates a system structure including the entities involved in some embodiments. The User Equipment (UE) 302 is a wireless terminal, such as a cellular smartphone, sometimes connected to the source network node 304 over a wireless interface 308 and sometimes connected to a target network node 306, to which the UE 302 is connected over a wireless interface 310. Further detail regarding the UE 302 and the network nodes 304, 306 is set out below with respect to FIGS. 14 and 15 respectively.

In the context of a mobility procedure, such as a LTM cell switch procedure or an inter-CU LTM cell switch procedure, for the UE, the source network node 304, sometimes also referred to as the serving network node, controls a source cell 314 (sometimes called serving cell or Special Cell (SpCell). The target network node 306 controls a target cell 316 (sometimes called target cell, neighbour cell, candidate cell, LTM candidate cell or inter-CU LTM candidate cell).

Each of source network node 304 and the target network node 306 may be a base station such as, when they e.g. are part of NG-RAN, e.g. gNB. The source network node and the target network node are connected over an interface 312, which may be an Xn or Xn-C type of interface, for example when the source network node and target network node are of type gNB and part of an NG-RAN.

In case of a distributed CU/DU RAN architecture, each of the source network node 304 and/or the target network node 306 may be divided into a distributed unit, sometimes known as gNB-DU or DU, and a central unit, CU, sometimes referred to as the serving CU, a gNB-CU, CU, gNB-CU-CP or gNB-CU-UP. Thus, in such a case the source network node 304 may be divided into a source central unit, CU 318 and a source distributed unit, DU, 320, and target network node 306 may be divided into a target central unit, CU 324 and a target distributed unit, DU, 326. The source CU 318 and the source DU 320 are connected over an interface 322, which may be an F1 type of interface in case of NG-RAN. Correspondingly, the target CU 324 and the target DU 326 are connected over an interface 328, which may be an F1 type of interface in case of NG-RAN.

The source network node 304 and the target network node 306 are connected to a third network node 330 over interfaces 332 and 334, respectively. The third network node 330 may be a core network node such as, in case of a 5G core network (5GC), a User Plane Function, UPF or an Access and Mobility management Function, AMF. In such a case the interfaces 332 and 334 may be an NG type of interface.

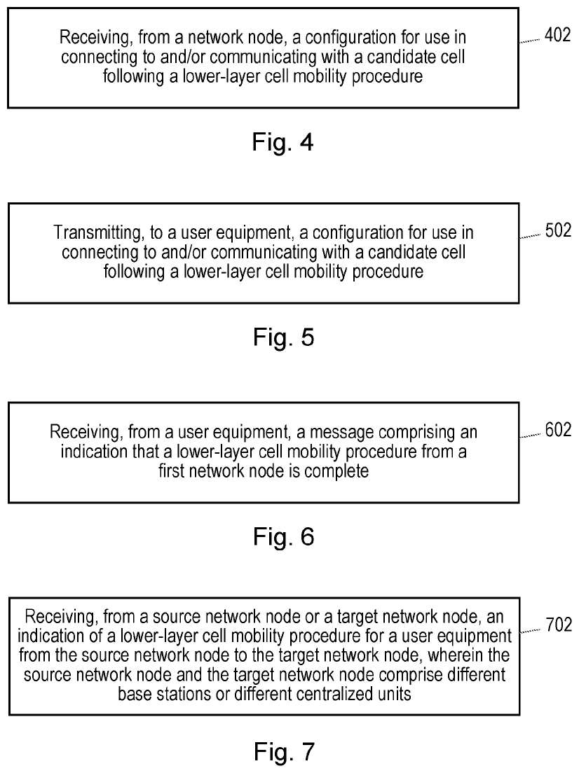

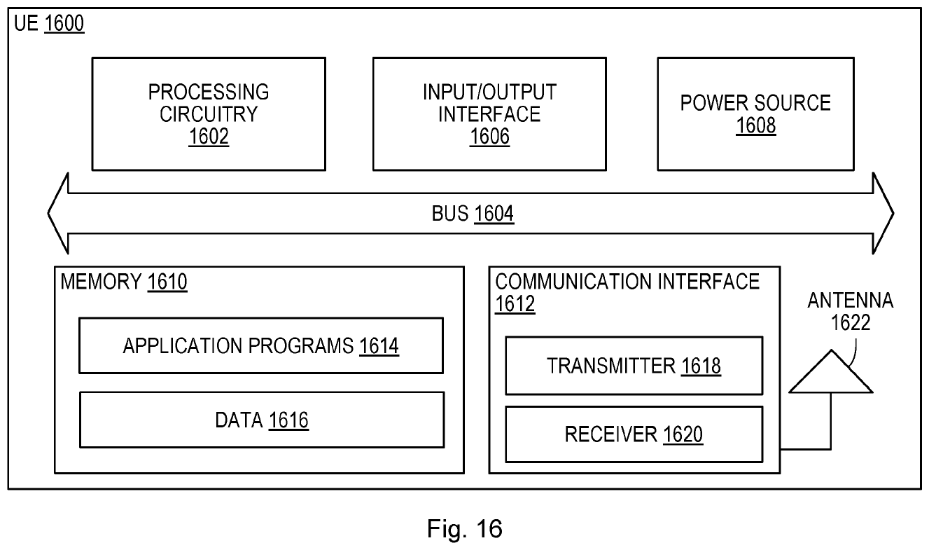

FIG. 4 depicts a method in accordance with particular embodiments. The method of FIG. 4 may be performed by a UE or wireless device (e.g. the UE 1512 or UE 1600 as described later with reference to FIGS. 15 and 16 respectively).

Complementary methods performed by a network node (also referred to herein as a first network node, e.g., a source network node), a second network node (also referred to herein as a target network node, e.g., a CU), and a core network node (also referred to herein as a third network node) are described with respect to FIGS. 5, 6 and 7 respectively. Further detail regarding the method of FIG. 4 and other methods performed by the UE is set out below in the sections “Embodiments in a UE” and “Detailed embodiments in a UE”.

The method of FIG. 4 comprises, at step 402, receiving, from a network node, a configuration for use in connecting to and/or communicating with a candidate cell following a lower-layer cell mobility procedure. The lower-layer cell mobility procedure comprises a cell switch from a source cell served by a first base station or a first centralized unit, CU, to a candidate cell served by a second base station or a second CU. For example, the configuration may correspond to, or be comprised in, the LTM cell switch command described below under the section “Detailed embodiments in a UE”.

The method of FIG. 4 may further comprise receiving, via lower-layer signalling from the first base station or the first CU, a command to switch to the candidate cell.

The command may comprise an indication that the candidate cell is served by a different CU or a different base station than the first base station or the first CU, or an instruction for the user equipment to refresh one or more security keys upon executing the lower-layer cell mobility procedure.

The lower-layer signalling may comprise one or more of: L1 and L2 signalling. Additionally or alternatively, the lower-layer signalling may comprise one or more of: Medium Access Control, MAC, signalling and Physical, PHY, layer signalling.

The method of FIG. 4 may further comprise applying the configuration and transmitting, to the candidate cell, a message comprising an indication that the lower-layer cell mobility procedure is complete.

The configuration may comprise at least a first part of information that enables the user equipment to refresh one or more security keys for use in connecting to and/or communicating with the candidate cell. The first part of information that enables the user equipment to refresh one or more security keys may comprise one or more of: an indication of a master key update parameter; an indication of one or more security algorithms to be used by the user equipment to derive one or more user plane keys and/or one or more control plane keys. The one or more security keys may comprise a master key for a network node serving the candidate cell.

The command may comprise at least a second part of information that enables the user equipment to refresh one or more security keys for use in connecting to and/or communicating with the candidate cell.

The second part of information may comprise an indication of the configuration to be applied by the user equipment for connecting to and/or communicating with the candidate cell.

The message comprising an indication that the lower-layer cell mobility procedure is complete may be transmitted using the refreshed one or more security keys.

In some embodiments, method of FIG. 4 may further comprise, upon executing the lower-layer cell mobility procedure to the candidate cell, using the information to determine one or more security keys; and using the one or more security keys to connect to and/or communicate with the candidate cell.

In alternative embodiments, method of FIG. 4 may further comprise: prior to executing the lower-layer cell mobility procedure to the candidate cell, using the information to determine one or more security keys; and upon executing the lower-layer cell mobility procedure, using the one or more security keys to connect to and/or communicate with the candidate cell.

The user equipment may use the information to determine the one or more security keys upon reception of the configuration.

The configuration may comprise one of: a full configuration; and a delta configuration defining one or more differences relative to a reference configuration.

The lower-layer cell mobility procedure may comprise an L1/L2 triggered mobility, LTM, procedure.

The method of FIG. 4 may further comprise: providing user data; and forwarding the user data to a host via the transmission to the network node.

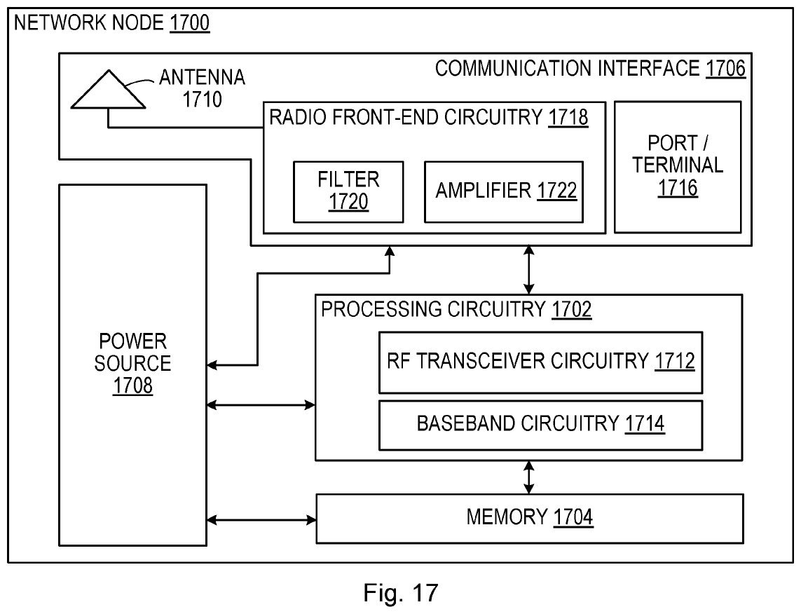

FIG. 5 depicts a method in accordance with particular embodiments. The method of FIG. 5 may be performed by a network node (e.g. the network node 1510 or network node 1700 as described later with reference to FIGS. 15 and 17 respectively). The network node may also be referred to herein as a first network node. In some embodiments, the network node is a source network node.

Complementary methods performed by a UE, a second network node (also referred to herein as a target network node, e.g., a CU) and a core network node are described with respect to FIGS. 4, 6 and 7 respectively. Further detail regarding the method of FIG. 5 and other methods performed by the network node is set out below in the sections “Embodiments in a network node” and “Detailed embodiments in a network node”.

The method of FIG. 5 comprises, at step 502, transmitting, to a user equipment, a configuration for use in connecting to and/or communicating with a candidate cell following a lower-layer cell mobility procedure. For example, the configuration may correspond to, or be comprised in, the LTM cell switch command described below under the sections “Embodiments in a network node” and “Detailed embodiments in a network node”.

The configuration may comprise a first part of information that enables the user equipment to refresh one or more security keys for use in connecting to and/or communicating with the candidate cell.

The first part of information that enables the user equipment to refresh one or more security keys may comprise one or more of: an indication of a master key update parameter; an indication of one or more security algorithms to be used by the user equipment to derive one or more user plane keys and/or one or more control plane keys.

The one or more security keys may comprise a master key for a network node serving the candidate cell.

The configuration may comprise an indication of one or more source cells, for use by the user equipment in determining whether to refresh the one or more security keys based on whether or not the lower-layer mobility procedure was from one of the one or more source cells.

The indication of one or more source cells may comprise one or more of: one or more cell IDs; one or more physical cell identifiers; one or more source cell configuration identifiers; and an identifier of a group of one or more cells.

The configuration may comprise one of: a full configuration; and a delta configuration defining one or more differences relative to a reference configuration.

The network node may comprise a first centralized unit, CU, or a first base station, and the candidate cell may be served by a second CU or a second base station.

The method of FIG. 5 may further comprise transmitting, via lower-layer signalling to the user equipment, a command to switch to the candidate cell. The command may comprise at least a second part of information that enables the user equipment to refresh one or more security keys for use in connecting to and/or communicating with the candidate cell. The second part of information may comprise an indication of the configuration to be applied by the user equipment for connecting to and/or communicating with the candidate cell.

The command may comprise an indication that the candidate cell is served by a different CU or a different base station than the source network node.

The lower-layer signalling may comprise one or more of: L1 and L2 signalling.

The lower-layer signalling may comprise one or more of: Medium Access Control, MAC, signalling and Physical, PHY, layer signalling.

The lower-layer cell mobility procedure may comprise an L1/L2 triggered mobility, LTM, procedure.

The method of FIG. 5 may further comprise: transmitting a request message to a second network node, comprising a request for the second network node to transmit the configuration for use in connecting to and/or communicating with the candidate cell following the lower-layer cell mobility procedure.

The request message may comprise a handover request message.

The request message may comprise a request for the second network node to transmit a plurality of configurations for a plurality of candidate cells served by the second network node.

The method of FIG. 5 may further comprise receiving, from the second network node, the configuration for use in connecting to and/or communicating with the candidate cell following the lower-layer cell mobility procedure.

FIG. 6 depicts a method in accordance with particular embodiments. The method of FIG. 6 may be performed by a second network node (e.g. the network node 1510 or network node 1700 as described later with reference to FIGS. 15 and 17 respectively). The second network node may be a CU, e.g., a CU serving a candidate cell. The second network node may also be referred to as a target network node, e.g., a target gNB, in the context of UE mobility.

Complementary methods performed by a UE, a network node (e.g., a source network node, a first network node), and a core network node are described with respect to FIGS. 3, 4 and 6 respectively. Further detail regarding the method of FIG. 5 and other methods performed by the second network node is set out below in the sections “Embodiments in a target network node” and “Detailed embodiments in a target network node”. The second network node may correspond to the target network node described therein.

The method of FIG. 6 comprises, at step 604, receiving, from a user equipment, a message comprising an indication that a lower-layer cell mobility procedure from a first network node is complete. For example, the message may correspond to the LTM cell switch complete message described below under the sections “Embodiments in a target network node” and “Detailed embodiments in a target network node”.

The message may comprise an indication that the first network node is a different base station or a different CU than the second network node.

The method of FIG. 6 may further comprise: receiving, from the first network node, a request message comprising a request for the second network node to transmit a configuration for use by the user equipment in connecting to and/or communicating with a candidate cell served by the second network node following the lower-layer cell mobility procedure.

The request message may comprise a request for the second network node to transmit a plurality of configurations for a plurality of candidate cells served by the second network node.

The method of FIG. 6 may further comprise: transmitting, to the first network node, the configuration for use in connecting to and/or communicating with the candidate cell following the lower-layer cell mobility procedure.

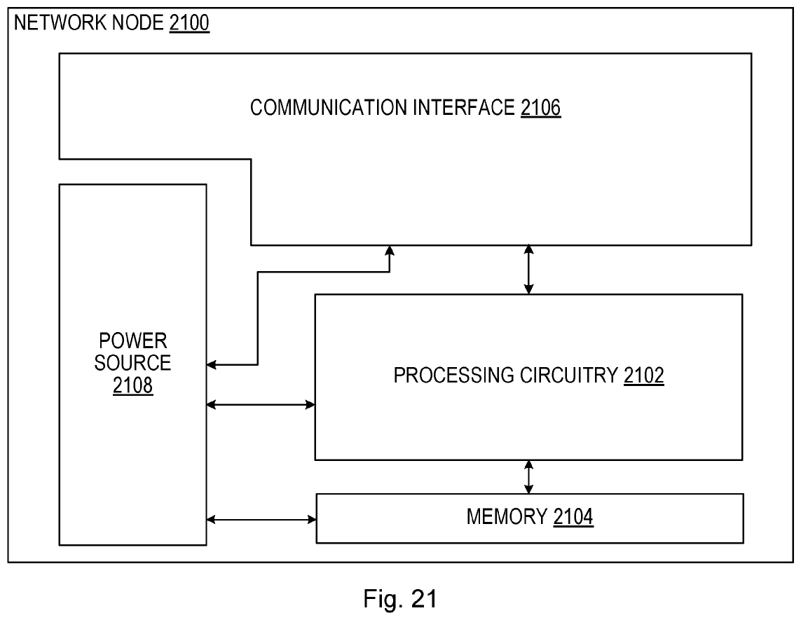

FIG. 7 depicts a method in accordance with particular embodiments. The method of FIG. 7 may be performed by a network node (e.g. the core network node 1508 or network node 2100 as described later with reference to FIGS. 15 and 21 respectively).

Complementary methods performed by a UE, a network node (e.g., a source network node, a first network node) and a second network node (e.g., a CU) are described with respect to FIGS. 4, 5 and 6 respectively.

The method comprises, at step 702, receiving, from a source network node or a target network node, an indication of a lower-layer cell mobility procedure for a user equipment from the source network node to the target network node. The source network node and the target network node comprise different base stations or different centralized units.

The method of FIG. 7 may further comprise, upon receiving the indication, performing a path switch for a connection of the user equipment, from a first data path between the core network and the source network node, to a second data path between the core network and the target network node.

The indication may be received from the source network node, and the method of FIG. 7 may further comprise transmitting, to the target network node, an indication of the lower-layer cell mobility procedure.

The method of FIG. 7 may further comprise receiving a response from the target network node comprising dynamic information, and transmitting, to the source network node, the dynamic information.

Further detail regarding embodiments described above is set out below.

### Embodiments in a User Equipment

According to some embodiments, there is provided a method performed by a User Equipment (UE), to execute an inter-CU LTM cell switch procedure, comprising receiving, from the network, at least one inter-CU LTM candidate cell configuration. The method may further comprise: receiving, from a source network node, an LTM cell switch command indicating an inter-CU LTM candidate cell configuration; applying the indicated inter-CU LTM candidate cell configuration; performing security key refresh; and transmitting, to a target network node, an LTM cell switch complete message.

In some embodiments, the UE transmits the LTM cell switch complete message based on the security key refresh e.g. the LTM cell switch complete message may be ciphered and/or integrity protected based on the newly derived/updated security keys, at least partially derived during the inter-CU LTM cell switch procedure.

The method may comprise the UE receiving, from the network, with the inter-CU LTM candidate cell configuration, a first part of security information enabling the UE to perform security key refresh (e.g. configuration of ciphering and integrity protection algorithm(s)); and/or, receiving a second part of security information in the LTM cell switch command indicating the inter-CU LTM candidate cell configuration, or in an RRC message; and performing security key refresh based on the first part of security information and the second part of the security information.

### Embodiments in a Network Node

According to some embodiments, there is provided a method performed by a network node, such as a source network node (e.g., a source gNB or a source CU), to handle an inter-CU LTM cell switch procedure for a UE, comprising, transmitting, to the UE, LTM cell switch command, indicating an inter-CU LTM candidate cell configuration and transmitting, to a target network node or a third network node, an indication of an inter-CU LTM cell switch procedure. The network node may be referred to herein as the first network node.

The method may comprise the source network node transmitting, to the UE, with an inter-CU LTM candidate cell configuration, a first part of security information enabling the UE to perform security key refresh (e.g. configuration of ciphering and integrity protection algorithm(s)); and/or, transmitting a second part of security information in the LTM cell switch command indicating the inter-CU LTM candidate cell configuration or in an RRC message; and, transmitting to a target network node at least parts of the first part of security information and/or the second part of the security information.

### Embodiments in a Target Network Node

According to some embodiments, there is provided a method performed by a second network node, such as a target network node (e.g., a target gNB or a target CU), to handle an inter-CU LTM cell switch procedure for a UE, comprising, receiving, from the UE, an LTM cell switch complete message indicating that the UE has executed an inter-CU LTM cell switch procedure.

In some embodiments, the target network node receives, from a source network node or a third network node, an indication of an inter-CU LTM cell switch procedure. The indication may include UE-specific security information, such as an updated NCC value.

In some embodiments, the received LTM cell switch complete message is based on a security key refresh performed by the UE as part of the inter-CU LTM cell switch procedure. e.g. the LTM cell switch complete message may be ciphered and/or integrity protected based on the newly derived security keys. Thus, the target network node may perform key refresh based on information to receive the LTM cell switch complete message, based on security related information in the UE context, possibly updated by the source network node and received by the target network node.

### Embodiments in a Third Network Node

According to some embodiments, there is provided a method performed by a third network node, such as a core network node (e.g. AMF or UPF) to handle an inter-CU LTM cell switch procedure for a UE, comprising, receiving, from a source network node, an indication of an inter-CU LTM cell switch procedure and transmitting, to a target network node, indication of an inter-CU LTM cell switch procedure.

Further detail regarding some embodiments of the present disclosure is set out in the following numbered statements.

### Detailed Embodiments in a UE

A1. A method performed by a User Equipment, UE, to execute an inter-CU LTM cell switch procedure, comprising receiving, from the network (e.g., a network node), at least one inter-CU LTM candidate cell configuration.

In some embodiments, the method may further comprise receiving, from a source network node, an LTM cell switch command indicating an inter-CU LTM candidate cell configuration.

In some embodiments, the method may further comprise applying the indicated inter-CU LTM candidate cell configuration.

In some embodiments, the method may further comprise transmitting, to a target network node, an LTM cell switch complete message.

A1a. The method in A1 wherein the LTM cell switch complete message indicates execution of an inter-CU LTM cell switch procedure.

The method in Ala wherein the indication of execution of an inter-CU LTM cell switch procedure is an indication of a target cell, target network node, source cell or source network node.

A2. The method in A1 wherein the UE performs security key refresh.

The method of A2, wherein the security key refresh comprises one or more of:
The UE receives a Master Key Update parameter/IE (e.g. masterKeyUpdate) included in the inter-CU LTM candidate cell configuration (e.g. set by the Target network node 306 or by the Target CU 328).
When a Non-Access Stratum (NAS) indication (e.g. nas-Container) is received (e.g. within the Master Key Update parameter/IE) the UE forwards the NAS indication to the upper layer (e.g. UE NAS layer);
When a key set change indication (e.g. keySetChangeIndicator) is received and/or is set to ‘true’ (e.g. within the Master Key Update parameter/IE) the UE derives or updates the K_{gNB} key based on the K_{AMF} key, as specified in TS 33.501 v18.1.0;
The UE derives or updates the K_{gNB} key (for the inter-CU LTM candidate cell configuration indicated in the LTM cell switch command) based on the current K_{gNB} key or the NH, using the Next Hop Chaining Count (e.g. nextHopChainingCount) value indicated in the received Master Key Update parameter/IE (e.g. MasterKeyUpdate), as specified in TS 33.501;
The UE derives the K_{RRCenc} and K_{UPenc} keys associated with a ciphering algorithm (e.g. cipheringAlgorithm indicated in the securityAlgorithmConfig), as specified in TS 33.501;
The UE derives the K_{RRCint} and K_{UPint} keys associated with an integrity protection algorithm (e.g. integrityProtAlgorithm indicated in the securityAlgorithmConfig), as specified in TS 33.501;
The UE receives a security algorithm configuration included in the inter-CU LTM candidate cell configuration, based on which the UE derives User plane keys and/or control plane keys (e.g. for encryption and/or integrity protection) e.g. the K_{RRCene} and K_{UPenc} keys, the K_{RRCint} and K_{UPint} keys.
The UE uses its current security algorithm configuration, based on which the UE derives User plane keys and/or control plane keys (e.g. for encryption and/or integrity protection) e.g. the K_{RRCene} and K_{UPenc} keys, the K_{RRCint} and K_{UPint} keys;
The UE applies the provided ciphering algorithm and key during an PDCP entity re-establishment procedure;
The UE applies the provided integrity protection algorithm and key during an PDCP entity re-establishment procedure.

A3. The method in A1 wherein the inter-CU LTM candidate cell configuration includes one of:
A first part of security information enabling the UE to perform security key refresh, e.g. the RRC IE MasterKeyUpdate or a RRC IE RadioBearerConfig that includes SecurityConfig with SecurityAlgorithmConfig
Indication to perform a full configuration, e.g. the RRC field fullConfig.

A4. The method in A1 wherein the UE transmits the LTM cell switch complete message based on the security key refresh e.g. the LTM cell switch complete message may be ciphered and/or integrity protected based on the newly derived security keys.

A4b. The method in A1 wherein the UE transmits the LTM cell switch complete message (e.g. an RRCReconfigurationComplete) when the inter-CU LTM candidate cell configuration includes an explicit indication, wherein the LTM cell switch complete message is ciphered and/or integrity protected based on the newly derived security keys, and is used to indicate to the target network node or target CU that the UE has successfully performed the key refresh. This may be used by the network only in inter-CU LTM cell switch procedure, when that indication is needed in the target network node or target CU.

A5. The method in A1 wherein upon reception of the LTM cell switch the UE perform a radio bearer reconfiguration e.g. adding a new bearer, removing a bearer, modifying a bearer, according to a radio bearer configuration included in the inter-CU LTM candidate cell configuration indicated in the LTM cell switch command. In that case, the radio bearer reconfiguration is set by the target network node or target CU (which is a different node compared to the source network node or source CU).

A5. The method in A1 wherein upon reception of the LTM cell switch command the UE perform a measurement configuration for RRM measurements (L3 measurements), e.g. adding a new measurement object (such as a MeasObjectNR, MeasObjectEUTRA), reporting configuration and/or measurement identity, and/or removing or modifying, according to a measurement configuration (IE MeasConfig in an RRCReconfiguration) included in the inter-CU LTM candidate cell configuration indicated in the LTM cell switch command. In that case, the radio bearer reconfiguration is set by the target network node or target CU (which is a different node compared to the source network node or source CU).

A6. The method in A1, wherein the parameters and configuration for executing a security key refresh are received by the UE in a second part of security information enabling the UE to perform security key refresh, outside of the inter-CU LTM candidate cell configuration. In such a case, the full set of parameters and configuration for the security key refresh can be included in the second part or, alternatively, only a minimum set is included in the second part so that the UE is able to perform a security key refresh.

In one option, the parameters and configuration for the security key refresh are included in the LTM cell switch command.

In one option, the parameters and configuration for the security key refresh are included in a new MAC CE that is different from the one used for the LTM cell switch command.

In one option, the parameters and configuration for the security key refresh are included in the same RRC message that includes the inter-CU LTM candidate cell configuration but outside of the inter-CU LTM candidate cell configuration.

With this option, the UE may perform a security key refresh to derive the security keys for the inter-CU LTM candidate cell configuration even before an LTM cell switch command is receive to trigger and LTM cell switch procedure. In such a case, the UE generates the security keys and store them until the time of the execution of an LTM cell switch (that is the time on when these security keys will be used).

In one option, the parameters and configuration for the security key refresh are included in an RRC message that is different from that one that includes the inter-CU LTM candidate cell configuration but outside of the inter-CU LTM candidate cell configuration.

With this option, the UE may perform a security key refresh to derive the security keys for the inter-CU LTM candidate cell configuration even before an LTM cell switch command is received to trigger and LTM cell switch procedure. In such a case, the UE generates the security keys and store them until the time of the execution of an LTM cell switch (that is the time on when these security keys will be used).

### Detailed Embodiments in a Network Node

B1. A method performed by a network node, such as a source network node (e.g., a source gNB or a source CU), to handle an inter-CU LTM cell switch procedure for a UE, comprising: transmitting, to the UE, an LTM cell switch command (e.g., a configuration for use in connecting to and/or communicating with a candidate cell following a lower-layer cell mobility procedure). The LTM cell switch command may indicate an inter-CU LTM candidate cell configuration.

The method may further comprise transmitting, to a target network node or a third network node, an indication of an inter-CU LTM cell switch procedure.

B1a. The method in B1 wherein the indication of an inter-CU LTM cell switch procedure contains one or more of the following:
Indication of LTM target cell
Indication of LTM execution to target cell
The latest UE configuration (e.g., UE context)
The identifier of the LTM candidate cell toward which the LTM cell switch is executed.
The list of current configured LTM candidate cells identifiers at the UE
The list of current RRCReconfiguration messages, each one used to configure an LTM candidate cell configuration, at the UE
A request to provide security configuration and parameters to be sent to the UE.
UE-specific security information, such as current NCC value used by the UE
The current LTM reference configuration at the UE
The list of current RS resources related to the configured LTM candidate cells at the UE
The list of current TCI states related to the configured LTM candidate cells at the UE
The list of current random access configurations for the early TA acquisition at the UE.
The list of current LTM candidate cells for which no L2 reset is needed at the UE.

B1b. The method in B1 wherein the indication of an inter-CU LTM cell switch procedure is within an existing XnAP message, such as the HANDOVER REQUEST message.

B1c. The method in B1, wherein the indication of an inter-CU LTM cell switch procedure is within a new XnAP message, such as the LTM CELL SWITCH REQUEST message.

B2. The method in B1 wherein the source network node receives, from a target network node or a third network node, a response including dynamic information.

In one example, the response includes also UE-specific security information, such as e.g. one or more of:
Indication whether security key is to be updated as part of the inter-CU LTM cell switch procedure;
Information regarding type of change of the security key/security configuration;
An (updated) nextHopChainingCount value (NCC) that the UE shall use in the target cell after the inter-CU LTM cell switch procedure;
A security algorithm configuration to be used for the target cell after the inter-CU LTM cell switch procedure.

B3. The method in B1 wherein the indication of an inter-CU LTM cell switch procedure is transmitted before the LTM cell switch command is transmitted.

In one example, the indication includes UE-specific security information, such as e.g. one or more of:
A request to provide security configuration and parameters to be sent to the UE.
An indication whether there is a need for a new security key (e.g. a new K_{gNB}) as part of the LTM cell switch procedure. In one option, the target node determines this based on that the indication is received from another CU (e.g. from another MN), so that the LTM cell switch procedure corresponds to an inter-CU LTM cell switch procedure;
UE-specific security information used in the current cell, such as current NCC value used by the UE.

B4. The method in B1 wherein the indication of an inter-CU LTM cell switch procedure is transmitted after the LTM cell switch command is transmitted.

In one example, the indication includes UE-specific security information, such as e.g. one or more of:
UE-specific security information used in the current cell, such as current NCC value used by the UE;
UE-specific security information, such as NCC value that is provided to the UE (e.g. in the LTM cell switch command) for use in the target cell after the inter-CU LTM cell switch procedure.

B5. The method in B2 wherein the response is received before the LTM cell switch command is transmitted.

B6. The method in B2 wherein received dynamic information is transmitted together with the LTM cell switch command.

B7. The method in B1 wherein the source network node transmits, to a target network node, an SN STATUS TRANSFER message.
The method of B7 wherein the SN STATUS TRANSFER message contains uplink PDCP SN receiver status or downlink PDCP SN transmitter status.

B8. The method in B1 wherein the source network node forwards, to the target network node, downlink data, received from a third network node.

B9. The method in B2 wherein the source network node receives, from a target network node, an existing XnAP message, such as HANDOVER REQUEST ACKNOWLEDGE message to indicate that the UE successfully accesses the target cell of the target network node.

B10. The method in B2 wherein the source network node receives, from a target network node, a new XnAP message, such as an LTM CELL SWITCH SUCCESS message or a HANDOVER SUCCESS message, to indicate that the UE successfully accesses the target cell of the target network node

B11. The method in B2 wherein the response includes an indicator of failure, such as an inter-CU LTM failure cause value.

B12. The method in B2 wherein the source network node receives, from a target network node, an existing XnAP message, such as HANDOVER SUCCESS message to indicate that the UE successfully accesses the target cell of the target network node.

B13. The method in B2 wherein the source network node receives, from a target network node, a new XnAP message, such as LTM CELL SWITCH SUCCESS message to indicate that the UE successfully accesses the target cell of the target network node.

### Detailed Embodiments in a Target Network Node

C1. Methods for a target network node, such as a target gNB or a target CU, to handle an inter-CU LTM cell switch procedure for a UE, comprising, receiving, from the UE, an LTM cell switch complete message.

C1a. The method in C1 wherein the LTM cell switch complete message indicates the UE has executed an inter-CU LTM cell switch procedure.

C2. The method in C1 wherein the target network node receives, from a source network node or a third network node, an indication of an inter-CU LTM cell switch procedure.

C2a. The method in C2 wherein the indication of an inter-CU LTM cell switch procedure contains one or more of the following:
Indication of LTM target cell
Indication of LTM execution to target cell
The latest UE configuration (e.g., UE context)
The identifier of the LTM candidate cell toward which the LTM cell switch is executed.
The list of current configured LTM candidate cells identifiers at the UE.
The list of current RRCReconfiguration messages, each one used to configure an LTM candidate cell configuration, at the UE
A request to provide security configuration and parameters to be sent to the UE
UE-specific security information, such as current NCC value used by the UE.
The current LTM reference configuration at the UE
The list of current RS resources related to the configured LTM candidate cells at the UE
The list of current TCI states related to the configured LTM candidate cells at the UE
The list of current random access configurations for the early TA acquisition at the UE
The list of current LTM candidate cells for which no L2 reset is needed at the UE

C2b. The method in C2 wherein the indication of an inter-CU LTM cell switch procedure is within an existing XnAP message, such as a new class 1 or class 2 message. One example is the HANDOVER REQUEST message.

C2c. The method in C2, wherein the indication of an inter-CU LTM cell switch procedure is within a new XnAP message, such as a new class 1 or class 2 message. One example is the LTM CELL SWITCH REQUEST message.

C3. The method in C1 wherein the target network node transmits, to a source network node or the third network node, a response including dynamic information.

C4. The method in C1 wherein the target network node transmits, to a source network node or a third network node, an HANDOVER SUCCESS message indicating that the UE has arrived in the target cell.

C4a. The method in C1 wherein the target network node transmits, to a target network node, a new XnAP message, such as LTM CELL SWITCH SUCCESS message to indicate that the UE successfully accesses the target cell of the target network node.

C5. The method in C1 wherein the target network node receives, from a source network node an SN STATUS TRANSFER message.

The method in C5 wherein the SN STATUS TRANSFER message contains uplink PDCP SN receiver status or downlink PDCP SN transmitter status.

C6. The method in C1 wherein the received LTM cell switch complete message is based on a security key refresh performed by the UE as part of the inter-CU LTM cell switch procedure. e.g. the LTM cell switch complete message may be ciphered and/or integrity protected based on the newly derived security keys.

C7. The method in C6 wherein security keys were derived based on an inter-CU LTM candidate cell configuration created by the target network node.

C8. The method in C1 wherein the target network node transmits, to a source network node or the third network node, a response including the cause for LTM failure.

C9. The method in C1 wherein the target network node transmits, to the third network node, a request to perform a path switch.

C10. The method in C9 wherein the target network node receives, from the third network node, a confirmation that a path switch was performed.

### Embodiments in a Third Network Node

E1. Methods for a third network node (e.g., a core network node or function), such as a User Plane Function, UPF or an Access and Mobility management Function, AMF, to handle an inter-CU LTM cell switch procedure for a UE, comprising, receiving, from a source network node or a target network node, an indication of an inter-CU LTM cell switch procedure.

E1a. The method in E1 wherein the indication is a request to perform a path switch.
The method in Ela, wherein the third network node performs a switch of the data path for the UE from the source network node to the target network node.

E2. The method in E1 wherein the third network node transmits, to a target network node, an indication of an inter-CU LTM cell switch procedure.
The method, wherein the indication is transmitted in response to the received indication.

E3. The method in E2 wherein the third network node receives, from the target network node, a response including dynamic information.

E4. The method in E1 wherein the third network node transmits, to the source network node a response including dynamic information.
The method in E4, wherein the transmitted response is transmitted in response to the received response.

E5. The method in E1 or Ela wherein the third network node transmits, to a target network node, a response message, such as a confirmation that a path switch was performed.

### Handling of Security Keys for Subsequent LTM

In legacy L3 Handover (reconfiguration with sync, change of PCell), the handover (HO) command (e.g. RRCReconfiguration) includes parameters and/or IEs set by the target gNodeB based on the source gNodeB and, possibly the UE's current configuration (enabling the target gNodeB to possibly generate a delta signaling). However, when a Candidate gNodeB is generating an RRCReconfiguration for a UE to be configured with LTM, and to be used for subsequent LTM (i.e. more than one LTM cell switch, coming from the initial source cell the UE was connected to when LTM was configured, or another candidate cell the UE has moved after that LTM candidate was configured), there may be at least one security parameter which would not be suitable any longer after the first LTM cell switch execution, such as security counters (e.g. next hop chaining counter), which would need to be incremented on an LTM cell switch. Another example is the indication of key refresh, which does not only depend on the target gNodeB the UE is going to, but also the gNodeB of the source cell the UE is coming from e.g. an LTM cell switch from a cell of the same gNodeB may not require key refresh, while an LTM cell switch from a cell of a different gNodeB requires key refresh, so that an indication for the UE to perform key refresh depends not only on the target cell, but also the source cell.

In a set of embodiments, the UE receives the information to perform security key refresh divided in at least two parts (a first part and a second part), wherein the first part is received in an RRC message (e.g. the RRC Reconfiguration message including the LTM configuration, which includes the configuration of least one LTM candidate cell) and the second part is received by the UE in a lower layer message (e.g. the LTM cell switch command, such as a MAC Control Element or Downlink Control indication), indicating an LTM candidate cell the UE needs to change to (e.g. by including an LTM candidate ID in the LTM cell switch command). Based on the at least two parts the UE performs the key refresh in the LTM cell switch (or determines not to perform key refresh based on at least one of the parts).

The first part may comprise one or more of the following characteristics:

In one option, the first part is included in the LTM candidate cell configuration, which is to be applied and used when the UE receives the LTM cell switch command associated to that cell. For deriving security keys in advance i.e. before the LTM cell switch, the UE would need to process the LTM candidate cell configuration.

In one option, the first part is included in an RRC Reconfiguration message the UE receives, wherein that RRC Reconfiguration (e.g. RRCReconfiguration message) includes an LTM candidate cell configuration associated to an LTM candidate identifier, and wherein the first part is also associated to the LTM candidate cell configuration e.g. by associating the first part with the LTM candidate cell identifier. In other words, the first part associated to the LTM candidate cell is outside the LTM candidate cell configuration, which allows the UE to use the first part without having the process the LTM candidate cell configuration, which can reduce the processing time needed before the LTM cell switch procedure.

In one option, the first part comprises one or more fields and or parameters which are static or semi-static, and/or parameters which are associated to the LTM candidate cell. These may be parameters that would not change depending on how many LTM cells switch have occurred or depending on source cell in which the UE receives the LTM cell switch command i.e. these parameters are not modified when subsequent LTM occurs. For example, when a target gNodeB configures a ciphering and/or integrity protection algorithm for one or more or its LTM candidate cell, these are to be used when key refresh is needed, no matter where the UE is coming from. Some other security information may not be like that, such as the actual indication that key refresh is to be performed: that would depend not only on the LTM candidate cell the UE is going to, but also the cell the UE is coming from (e.g. cell in which the UE receives the LTM cell switch command).

In one option, the first part includes an indication indicating to the UE that the UE shall perform key refresh when performing LTM cell switch to that associated LTM candidate cell. The indication may be, for example, the Master Key Update parameter/IE (e.g. masterKeyUpdate) set to ‘TRUE’, or any other indication that key refresh or change is needed. When the UE receives that parameter/IE the UE knows that a key change/refresh is needed when the LTM cell switch occurs towards that LTM target candidate cell i.e. when the UE is changing SpCell e.g. changing PCell in a reconfiguration with sync.

In one sub-option, the association to the LTM candidate cell is further associated to a source cell in which the UE receives the LTM cell switch command. In other words, for each LTM candidate cell the UE may receive, in the RRC message, multiple values of the indication (e.g. Master Key Update parameter or an equivalent parameter or IE indication that key refresh/change is needed), wherein each of the multiple values is associated to an incoming or source cell in which the UE may receive an LTM cell switch command i.e. the indication is associated to the source and target cell. Suppose the UE is configured with candidate cell A, candidate cell B, candidate cell C and candidate cell D. For candidate cell D, the UE may receive the indication set to TRUE or FALSE, depending on which incoming cell the UE comes from, because key refresh may depends on the cell the UE is going to (candidate cell) but also the cell the UE is coming from. An example of the configuration the UE receives is the following:
LTM Candidate A
   When source is candidate B, key refresh indication set to FALSE;
   When source is candidate C, key refresh indication set to FALSE;
   When source is candidate D, key refresh indication set to TRUE;
   When source is candidate E, key refresh indication set to TRUE;
   When source is candidate F, key refresh indication set to TRUE;
LTM Candidate B
   When source is candidate A, key refresh indication set to FALSE;
   When source is candidate C, key refresh indication set to FALSE;
   When source is candidate D, key refresh indication set to TRUE;
   When source is candidate E, key refresh indication set to TRUE;
   When source is candidate F, key refresh indication set to TRUE;
LTM Candidate C
   When source is candidate A, key refresh indication set to FALSE;
   When source is candidate B, key refresh indication set to FALSE;
   When source is candidate D, key refresh indication set to TRUE;
   When source is candidate E, key refresh indication set to TRUE;
   When source is candidate F, key refresh indication set to TRUE;
LTM Candidate C
   When source is candidate A, key refresh indication set to FALSE;
   When source is candidate B, key refresh indication set to FALSE;
   When source is candidate D, key refresh indication set to TRUE;
   When source is candidate E, key refresh indication set to TRUE;
   When source is candidate F, key refresh indication set to TRUE;
LTM Candidate D
   When source is candidate A, key refresh indication set to TRUE;
   When source is candidate B, key refresh indication set to TRUE;
   When source is candidate C, key refresh indication set to TRUE;
   When source is candidate E, key refresh indication set to FALSE;
   When source is candidate F, key refresh indication set to FALSE;
LTM Candidate E
   When source is candidate A, key refresh indication set to TRUE;
   When source is candidate B, key refresh indication set to TRUE;
   When source is candidate C, key refresh indication set to TRUE;
   When source is candidate F, key refresh indication set to FALSE;
   When source is candidate G, key refresh indication set to FALSE;
LTM Candidate F
   When source is candidate A, key refresh indication set to TRUE;
   When source is candidate B, key refresh indication set to TRUE;
   When source is candidate C, key refresh indication set to TRUE;
   When source is candidate E, key refresh indication set to FALSE;
   When source is candidate G, key refresh indication set to FALSE;
LTM Candidate G
   When source is candidate A, key refresh indication set to TRUE;
   When source is candidate B, key refresh indication set to TRUE;
   When source is candidate C, key refresh indication set to TRUE;
   When source is candidate E, key refresh indication set to FALSE;
   When source is candidate F, key refresh indication set to FALSE;

The example above may reflect the fact that cells A, B, C are of a first gNodeB while the cells D, E, F are of a second gNodeB, so that LTM cell switch between cells within the same gNodeB may happen without key refresh, while LTM cell switch between cells of different gNodeBs require key refresh.

Another alternative is the UE receiving a configuration comprising sets or lists of cells, to indicate to the UE that LTM cell switch from/to (i.e. between) cells within the same set or group do not lead to a key refresh, while LTM cell switch from/to (i.e. between) cells from different sets or groups triggers the UE to perform key refresh.

For example, if a first set or group includes cells A, B, C and a second set includes cells D, E, F, an LTM cell switch between A, B (i.e. from A to B, or B to A); or between B, C; or between A, C would not lead to key refresh, while an LTM cell switch from any of cells (A, B, C) to any of the cells (D, E, F) would trigger the UE to perform key refresh. In that sense, the UE could receive, for example, the following configuration:
Cells for which key refresh is not needed for LTM cell switch between them: Cell A, B, C
Cells for which key refresh is not needed for LTM cell switch between them: Cell D, E, F
LTM cell switch between cells from different groups triggers the UE to perform LTM cell switch;
In one option, the first part includes a Non-Access Stratum container (e.g. nas-Container defined as a OCTET STRING), used to transfer UE specific NAS layer information between the network and the UE. As in the previous case, that may either be associated to an LTM candidate cell, or to a pair of LTM candidate cell and incoming cell, so that the parameter may be present or not for a given candidate, depending on whether the UE is triggering the LTM cell switch from one cell or another. For example, if the UE has a first set of candidate cells A, B, C and a second set D, E, F (as in the previous example), the UE may have received a NAS container to be used when an LTM cell switch is to be performed between A and D, but not between A, B, C. In that case, the configuration may need to be per cell pair, in the first part e.g. in the RRC Reconfiguration message configuring the LTM candidate cell(s).

In one option, the first part includes a key set change indication (e.g. keySetChangeIndicator), which may either be set to true or false.

When the key set change indication is set to ‘true’ (e.g. within the Master Key Update parameter/IE), it indicates to the UE that the needs to derive or update one or more security keys associated to a Radio Access Network (RAN) node, such as the K_{gNB} key, based on one or more keys associated to a Core Network (CN) node, such as the K_{AMF} key, wherein the key(s) are derived and/or updated according to one or more rules (which may need further input parameters, such as frequency of the LTM candidate cell and/or a cell identifier of the LTM candidate cell);
When the key set change indication is set to ‘false’, it indicates to the UE that the UE needs to derive or update one or more security keys associated to a target RAN node, such as the K_{gNB} key associated to the target gNodeB, based on the current RAN node key, such as the K_{gNB} key associate dot the source gNodeB, or the NH parameter, using a Next Hop Chaining Count value (e.g. nextHopChainingCount value) indicated in the received MasterKeyUpdate, either as part of the first part or as part of the second part;
In one option, the key set change indication is associated to an LTM candidate cell e.g. for cell B the key set change indication is set to ‘true’. So, when the UE performs an LTM cell switch to cell B, the UE derives or updates one or more security keys associated to a RAN node, such as the K_{gNB} key, based on one or more keys associated to the CN node, such as the K_{AMF} key.

In one option, the key set change indication is associated to an LTM candidate cell and the cell in which a source cell, i.e., the cell in which the UE receives the LTM cell switch command (e.g. MAC CE indicating the LTM candidate cell). For example, the UE may be configured with LTM candidate cells A, B, C, D, E, F, and, for each cell pair, the UE receives a key set indication, as follows:
LTM candidate cell A
   When source is B, key set change indication is set to ‘false’
   When source is C, key set change indication is set to ‘false’
   When source is D, key set change indication is set to ‘true’
   When source is E, key set change indication is set to ‘true’
   When source is F, key set change indication is set to ‘true’
LTM candidate cell B
   When source is A, key set change indication is set to ‘false’
   When source is C, key set change indication is set to ‘false’
   When source is D, key set change indication is set to ‘true’
   When source is E, key set change indication is set to ‘true’
   When source is F, key set change indication is set to ‘true’
LTM candidate cell C
   When source is A, key set change indication is set to ‘false’
   When source is B, key set change indication is set to ‘false’
   When source is D, key set change indication is set to ‘true’
   When source is E, key set change indication is set to ‘true’
   When source is F, key set change indication is set to ‘true’
LTM candidate cell D
   When source is A, key set change indication is set to ‘true’
   When source is B, key set change indication is set to ‘true’
   When source is C, key set change indication is set to ‘true’
   When source is E, key set change indication is set to ‘false’
   When source is F, key set change indication is set to ‘false’
LTM candidate cell E
   When source is A, key set change indication is set to ‘true’
   When source is B, key set change indication is set to ‘true’
   When source is C, key set change indication is set to ‘true’
   When source is D, key set change indication is set to ‘false’
   When source is F, key set change indication is set to ‘false’
LTM candidate cell F
   When source is A, key set change indication is set to ‘true’
   When source is B, key set change indication is set to ‘true’
   When source is C, key set change indication is set to ‘true’
   When source is D, key set change indication is set to ‘false’
   When source is E, key set change indication is set to ‘false’

When the key set indication parameter is set to ‘false’, the UE needs to derive or update one or more security keys associated to a target RAN node, such as the K_{gNB} key associated to the target gNodeB, based on the current RAN node key, such as the K_{gNB} key associated to the source gNodeB, or the NH parameter, using a Next Hop Chaining Count value (e.g. nextHopChainingCount value).

In one option, the Next Hop Chaining Count value is also provided in the first part (i.e. received in the RRC message), also associated with the key set indication parameter and, consequently to the cell pair e.g. when the configuration the UE receives indicates that for LTM candidate cell F (shown above), when source is E, key set change indication is set to false, the configuration may also include the associated Next Hop Chaining Count value.

In another option, the Next Hop Chaining Count value is provided in the second part (i.e. received in the lower layer signaling, like in the LTM cell switch command). For example, when the configuration the UE receives indicates that for LTM candidate cell F (shown above), when source cell is cell E the key set change indication is set to ‘false’, and when in LTM cell switch indicates cell F, the UE also receives an associated Next Hop Chaining Count value, the UE derives or updates one or more security keys associated to a target RAN node, such as the K_{gNB} key associated to the target gNodeB, based on the NH parameter or the current the K_{gNB} key, using the received Next Hop Chaining Count value (e.g. nextHopChainingCount value). That received Next Hop Chaining Count value is stored by the UE and the UE derives the ciphering and integrity protection keys for UP and/or CP for the target cell based on the newly derived RAN node key e.g. K_{gNB} key.
In that case, since the Next Hop Chaining count value is received in the LTM cell switch command, it may be argued that the UE may not be able to calculate the security keys in advance i.e. before it receives the LTM cell switch command. However, since the Next Hop Chaining count value is either the same as the previous value the UE has stored (e.g. horizontal key refresh) or an incremented value (e.g. vertical key refresh), the UE may derive in advance (i.e. before the reception of the LTM cell switch command) two K_{gNB} key per LTM candidate cell for which a Next Hop Chaining count value is expected in the LTM cell switch command e.g. when for a given LTM candidate cell and the current source cell the UE is in the key set indicator is set to ‘false’.

In another option the UE receives a Next Hop Chaining Count value in the first part and stores it, e.g. when the key set indicator is set to ‘false’. When the UE receives an LTM cell switch command and perform LTM cell switch with key refresh (e.g. key set indicator set to ‘false’) the UE increments the Next Hop Chaining count value by one, autonomously. At the network side, the gNodeB also needs to keep maintain, in the UE context, the increments in the Next hop Chaining Count, as that needs to be aligned between the UE and the network, so both UE and network after LTM cell switch have the same K_{gNB} and, consequently, the same ciphering/and integrity protection keys. In that option, the UE would always have to increment at every LTM cell switch. The value could be reset (modified) upon reception of a new value in an RR message e.g. in a reconfiguration with sync.
One benefit of letting the UE increment the count without the need to receive it in the second part is that the count is not transmitted without integrity protection and uncyphered/unencrypted to the UE, in the LTM cell switch command.

In another option the UE receives a Next Hop Chaining Count value in the first part and stores it, e.g. when the key set indicator is set to ‘false’. In addition to it, the UE also receives in a first part an indication of which LTM candidate cells are cells for which an LTM cell switch leads to a horizontal key derivation i.e. without the need to increment the Next Hop Chaining count value; and an indication of which LTM candidate cells are cells for which an LTM cell switch leads to a vertical key derivation i.e. with the need to without the need to increment the Next Hop Chaining count value. For example, the UE may receive the following configuration for LTM candidate cell A.
LTM candidate cell A
   i. When source is B, key set change indication is set to ‘false’
      a. Horizontal key derivation indication (i.e. no increment of next hop chaining count upon LTM cell switch from A to B)
   ii. When source is C, key set change indication is set to ‘false’
      a. Vertical key derivation indication (i.e. increment of next hop chaining count upon LTM cell switch from A to B)
   iii. When source is D, key set change indication is set to ‘true’
   iv. When source is E, key set change indication is set to ‘true’
   v. When source is F, key set change indication is set to ‘true’
   vi. One benefit of letting the UE increment or not the count based on the indication included in the first part i.e. in the RRC message, is that the count is not transmitted without integrity protection and uncyphered/unencrypted to the UE, in the LTM cell switch command.

In one option, the first part includes a ciphering algorithm (e.g. cipheringAlgorithm indicated in the securityAlgorithmConfig);

In one option, the first part includes an integrity protection algorithm (e.g. integrityProtAlgorithm indicated in the securityAlgorithmConfig);

The second part may comprise one or more of the following options.

In one option, the second part includes an indication indicating to the UE that the UE shall perform key refresh when performing LTM cell switch to that associated LTM candidate cell. The indication may be, for example, one or more bits set to a value in the LTM cell switch command, for example, a value 0 or 1 in the LTM Cell Switch command MAC CE) e.g. value 0 indicates there is no need to perform key refresh, and value 1 indicates the UE shall perform key refresh. When the UE receives one of the values in the LTM cell switch command the UE knows that a key change/refresh is needed towards the indicated LTM target candidate cell in the LTM cell Switch command. In one sub-option, that may indicate the UE needs to perform key refresh, but to derive one or more security keys, further parameters need to be obtained in the first part. For example, in the RRC Reconfiguration in which the UE receives the LTM candidate configuration the UE obtains the security algorithm configuration(s), and/or on other properties of the LTM candidate cell such as frequency (e.g. SSB frequency) and/or physical cell identifier.

One possible benefit in including the indication in the LTM cell switch command is that determining the need to perform key refresh or not, depends not only on the LTM candidate cell the UE is going to with the LTM cell switch, but also the serving cell the UE is coming from. In particular, whether these cells are within the same CU, or, to be more precise, under the same PDCP entity and/or CU-User Plane entity. Thus, key refresh may be necessary when moving to cell B if the UE comes from cell E, but not from cell A.

Then, including the indication of key refresh in the second part instead of in the first part (RRC message provided when the UE is configured with LTM) is beneficial for subsequent LTM, since in each LTM cell switch the value of that indication may differ for the same LTM candidate cell, as it would depend on the serving cell (cell in which the UE receives the LTM cell switch). Compared to the case in which cell pairs are provided in RRC, that would possibly provide lower signaling overhead, as only a single value is provided in each cell switch i.e. there is no need to signal that for each cell pair of serving and LTM candidate cell.

However, even if in that solution the UE becomes aware that key refresh is needed or not during LTM cell switch, upon reception of the LTM cell switch command, that might not be possible at the network side. In other words, according to the method, the source network node which transmits the LTM cell switch needs to be aware that for a given LTM candidate cell, LTM cell switch with security key refresh (e.g. called here inter-CU LTM cell switch) is necessary, so it may set the respective value for the indication.

In one option (Approach 1), during the LTM preparation the S-DU receives an indication of LTM candidate cells (e.g. list of LTM candidate identifiers, or other identifier of the LTM candidate cells which may be reported by the UE and selected by the S-DU for LTM cell switch) to which key refresh would be necessary e.g. cells which are not under the same CU of that S-DU.

In other words, the S-DU may receive the LTM candidates, and an indication for the ones in which key refresh is needed, if the UE comes from that S-DU. For example, the network topology may be the following:
S-DU: cells A, B
C-DU in the same CU as the S-DU: cell C
C-DU in another CU: cells D, E, F

The S-DU may receive from the CU (e.g. source CU of the S-DU) an indication about cells C, D, E, F; or, simply an indication that for cells D, E, F key refresh is needed (so the S-DU derives that it is not needed if it selects other LTM candidates for LTM cell switch)

In another option (Approach 2), when the S-DU determines to perform LTM cell switch to an LTM candidate cell (e.g. cell E) coming from A (cell of the S-DU) the S-DU sends that indication to the S-CU which obtains from the target network node (e.g. target gNodeB, target gNB-CU) the MAC CE or information to be included in the MAC CE, including the indication on whether key refresh is needed or not. Notice in this case that it is the target network node which determines on whether key refresh is needed or not, based on the knowledge about which cell the UE is coming from.

In one option, the second part includes a key set change indication (e.g. keySetChangeIndicator) which take a first value associated to a flag ‘true’, or a second value associated to a flag ‘false’.

When the value is set associated to the flag ‘true’, it indicates to the UE that the UE needs to derive or update one or more security keys associated to the RAN target node, such as the K_{gNB} key, based on one or more keys associated to a CN node, such as the K_{AMF} key, wherein the key(s) are derived and/or updated according to one or more rules (which may need further input parameters, such as frequency of the LTM candidate cell and/or a cell identifier of the LTM candidate cell);

When the value is set associated to the flag ‘false’, it indicates to the UE that the UE needs to derive or update one or more security keys associated to a target RAN node, such as the K_{gNB} key associated to the target gNodeB, based on the current RAN node key, such as the K_{gNB} key associated to the source gNodeB, or the NH parameter, using a Next Hop Chaining Count value (e.g. nextHopChainingCount value), either as part of the first part or, as part of the second part.

In one option, the UE receives the LTM cell switch command which includes the key set change indication (set to a value associated to the flag ‘false’) and the next hop chaining count value.

The value(s) associated to the flags true or false may be, for example, one or more bits set to a value in the LTM cell switch command. For example, a value 0 or 1 in the LTM Cell Switch command MAC CE) e.g. value 0 indicates ‘false’ and value 1 indicates ‘true’. When the UE receives one of the values in the LTM cell switch command the UE knows whether to perform key refresh based on a CN security key (K_{AMF}) or based on the current RAN node key or the NH parameter. For example, when the value for the key set change indication is associated to a ‘true’ and is included in the LTM cell switch indicating an LTM candidate cell e.g. for cell B, when the UE performs an LTM cell switch to cell B, the UE derives or updates one or more security keys associated to a RAN node, such as the K_{gNB} key, based on one or more keys associated to the CN node, such as the K_{AMF} key.

One possible benefit in including the key set change indication in the LTM cell switch command is that determining the need to perform key refresh or not, depends not only on the LTM candidate cell the UE is going to with the LTM cell switch, but also the serving cell the UE is coming from.

Then, including the key set change indication in the second part instead of in the first part (RRC message provided when the UE is configured with LTM) is beneficial for subsequent LTM, since in each LTM cell switch the value of that indication may differ for the same LTM candidate cell, as it would depend on the serving cell (cell in which the UE receives the LTM cell switch). Compared to the case in which cell pairs are provided in RRC, that would possibly provide lower signaling overhead, as only a single value is provided in each cell switch i.e. there is no need to signal that for each cell pair of serving and LTM candidate cell.

However, since in that solution the UE becomes aware of the key set change indication during LTM cell switch, upon reception of the LTM cell switch command, the source network node which transmits the LTM cell switch needs to be aware of the value for the key set change indication for a given LTM candidate cell, when the UE comes from a cell in that S-DU.

In one option (Approach 1), during the LTM preparation the S-DU receives an indication of LTM candidate cells (e.g. list of LTM candidate identifiers, or other identifier of the LTM candidate cells which may be reported by the UE and selected by the S-DU for LTM cell switch) to which the key set change indication needs to be set to ‘one of the values e.g. cells which are not under the same CU of that S-DU. For example, assuming the UE is in cell A, for LTM candidate cells D, E, F the key set change indication is set to ‘true’, while for LTM candidate cells G, H the key set change indication is set to ‘false’.

In another option (Approach 2), when the S-DU determines to perform LTM cell switch to an LTM candidate cell (e.g. cell E) coming from A (cell of the S-DU) the S-DU sends that indication to the S-CU which obtains from the target network node (e.g. target gNodeB, target gNB-CU) the MAC CE or information to be included in the MAC CE, including the value for the key set indication change. Notice in this case that it is the target network node which determines on whether key refresh is needed or not, based on the knowledge about which cell the UE is coming from.

In one alternative to the above option, the second part includes another indication to UE to indicate whether a new security key (e.g. a new K_{gNB} key) needs to be derived for the target cell at the LTM cell switch, or not. In one example it is an indication that the target cell of the LTM cell switch belongs to another MN/CU than the current cell, i.e. that the cell switch corresponds to an inter-CU LTM cell switch procedure. In one example, the UE determines that it shall derive a new security key (e.g. a new K_{gNB} key), e.g. based on information in the first part of the UE security configuration in the LTM candidate cell configuration, in case the cell switch corresponds to an inter-CU LTM cell switch procedure, and not derive a new security key (e.g. K_{gNB}) in case the cell switch does not correspond to an inter-CU LTM cell switch procedure.

When the LTM cell switch command including a value for the key set indication parameter associated to the flag ‘false’, the UE needs to derive or update one or more security keys associated to a target RAN node, such as the K_{gNB} key associated to the target gNodeB, based on the current RAN node key, such as the K_{gNB} key associated to the source gNodeB, or the NH parameter, using a Next Hop Chaining Count value (e.g. nextHopChainingCount value).

In one option, the Next Hop Chaining Count value is also provided in the second part (i.e. received in the lower layer signaling, like in the LTM cell switch command). For example, the UE receives the LTM cell Switch command including an indication of the LTM candidate cell F, the key set change indication with a value (to indicate flag ‘false’), and an associated Next Hop Chaining Count value, based on which the UE derives or updates one or more security keys associated to a target RAN node, such as the K_{gNB} key associated to the target gNodeB, based on the NH parameter or the current the K_{gNB} key, using the received Next Hop Chaining Count value (e.g. nextHopChainingCount value). That received Next Hop Chaining Count value is stored by the UE and the UE derives the ciphering and integrity protection keys for UP and/or CP for the target cell based on the newly derived RAN node key e.g. K_{gNB} key.

In that case, since the Next Hop Chaining count value is received in the LTM cell switch command, it may be argued that the UE may not be able to calculate the security keys in advance i.e. before it receives the LTM cell switch command. However, since the Next Hop Chaining count value is either the same as the previous value the UE has stored (e.g. horizontal key refresh) or an incremented value (e.g. vertical key refresh), the UE may derive in advance (i.e. before the reception of the LTM cell switch command) two K_{gNB} keys per LTM candidate cell for which a Next Hop Chaining count value is expected in the LTM cell switch command e.g. when for a given LTM candidate cell and the current source cell the UE is in the key set indicator is set to ‘false’. In one option, the second part includes an indication of a ciphering algorithm (e.g. cipheringAlgorithm indicated in the securityAlgorithmConfig).

In one option, the second part includes an indication of an integrity protection algorithm (e.g. integrityProtAlgorithm indicated in the securityAlgorithmConfig).

As discussed above, the UE receives a first part of the security information in the RRC message, and a second part of the security information in the LTM Cell switch Command (e.g. MAC CE indicating the LTM candidate cell the UE switches to). As shown above, there are different alternatives and, in some cases, the same information could either be in the first or second part, with different benefits for different alternatives, and the method comprises different combinations of the above. In one possible embodiment, the UE receives in the first part the algorithm configuration(s), while the remaining information necessary is received in the LTM cell switch command e.g. Next Hop Chaining Count, key set indication, etc.

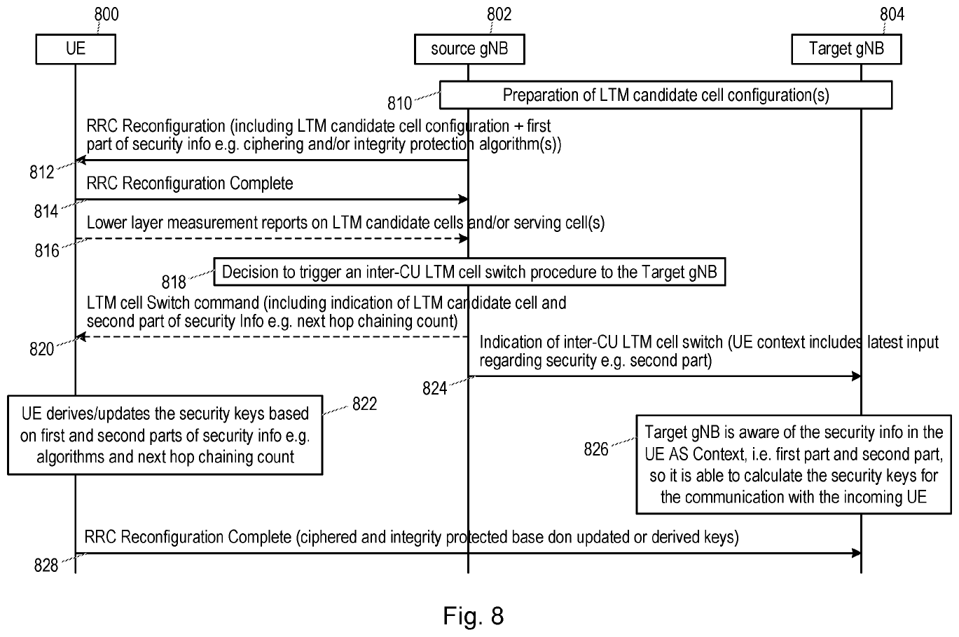

FIG. 8 shows one example, including signalling between a UE 800, a source gNB 802 and a target gNB 804:
Step 810. The source gNB 802 and the target gNB 804 prepare one or more LTM candidate cell configurations.
Step 812. The source gNB 802 transmits an RRC Reconfiguration message to the UE 800. The message includes the LTM candidate cell configuration(s) and a first part of security information (e.g., ciphering and/or integrity protection algorithm(s).
Step 814. The UE 800 transmits an RRC Reconfiguration Complete message to the source gNB 802.
Step 816. The UE 800 transmits lower-layer measurement reports on the LTM candidate cell(s) and/or serving cell(s), to the source gNB 802.
Step 818. The source gNB 802 decides to trigger an inter-CU LTM cell switch procedure to a target cell, in this example, a target cell controlled by the target gNB 804.
Step 820. The source gNB 802 transmits an LTM cell switch command to the UE 800. The LTM cell switch command contains an indication of an inter-CU LTM candidate cell configuration for the target cell, and also a second part of the security information (e.g., next hop chaining count).
Step 822. The UE 800 derives or updates its security keys based on the first and second parts of the security information, e.g., algorithms and next-hop chaining count.
Step 824. The source gNB 802 transmits an indication about the execution of an inter-CU LTM cell switch procedure to the target gNB 804. The indication includes, for example, the UE context comprising latest input regarding security (e.g., the second part of the security information).
Step 826. The target gNB 804 becomes aware of the security information in the UE access stratum (AS) context (i.e., the first and second parts of the security information), so is able to calculate the security keys for communication with the incoming UE 800.
Step 828. The UE 800 transmits an RRC Reconfiguration Complete message to the target gNB 804. The message is ciphered and integrity protected based on the updated/derived security keys.

It has also been mentioned that the second part is carried in a lower layer signaling, like the LTM cell switch command. However, the method also comprises other alternatives in which the second part could be carried in other lower layer signaling which is received by the UE before the LTM cell switch command (e.g. a MAC CE including a Time Advance Value and/or a TCI state and/or a beam indication), or concatenated with the LTM cell switch command.

In another option, the first part comprises one or more fields and or parameters which are static or semi-static, and/or parameters which are associated to a set of LTM target candidate(s). For example, the UE may receive a parameter type with a certain value associated to candidate cells: cell A, cell B, cell C and another parameter type with possibly another value associated to another set of candidate cells: cell D, cell E, cell F.

In one option, according to the method, at least one parameter which is part of the security information in the second part which is included in a lower layer signaling, like in the LTM cell switch MAC CE one or more security related information in the LTM cell switch command, is encrypted (ciphered). In one sub-option, that is ciphered based on the current ciphering key the UE is using, associated to the source cell in which the UE receives the LTM cell switch command. Thus, when the UE receives the LTM cell switch command the UE knows which field of the command (e.g. fields in a MAC CE) are ciphered, and, deciphers the parameter before it uses to derive the new keys.

In one option, the target node of the LTM cell switch procedure (e.g. an inter-CU LTM cell switch procedure), which then becomes the serving node for the UE, sends an indication to the (other) candidate nodes for LTM cell switch to inform about the security configuration that is to be used for the UE in case of an LTM cell switch to a cell of that candidate node. This is since the just executed LTM cell switch procedure can lead to that the security configuration to be used at the next (subsequent) LTM cell switch, to another candidate node, may need to be updated. As an example, the NCC value to be used at the next LTM cell switch may need to be increased. By providing this information to the different candidate nodes, the corresponding information does not need to be provided to the target node during the actual LTM cell switch execution for the next LTM cell switch procedure.

In one example, the indication includes one or more of the following:
A request to provide security configuration and parameters to be sent to the UE.
An indication whether there is a need for a new security key (e.g. a new K_{gNB}) as part of the LTM cell switch procedure. In one option, the target node determines this based on that the indication is received from another CU (e.g. from another MN), so that the LTM cell switch procedure corresponds to an inter-CU LTM cell switch procedure;
UE-specific security information used in the current cell, such as current NCC value used by the UE.

In case the indication includes a request to provide security configuration and parameters to be sent to the UE, a response message may be received from the candidate node with updated security configuration for the UE to be used after a subsequent LTM cell switch to that node. This information can then be stored by the serving node and, e.g., be provided to the UE in the LTM cell switch command that that target cell/node.

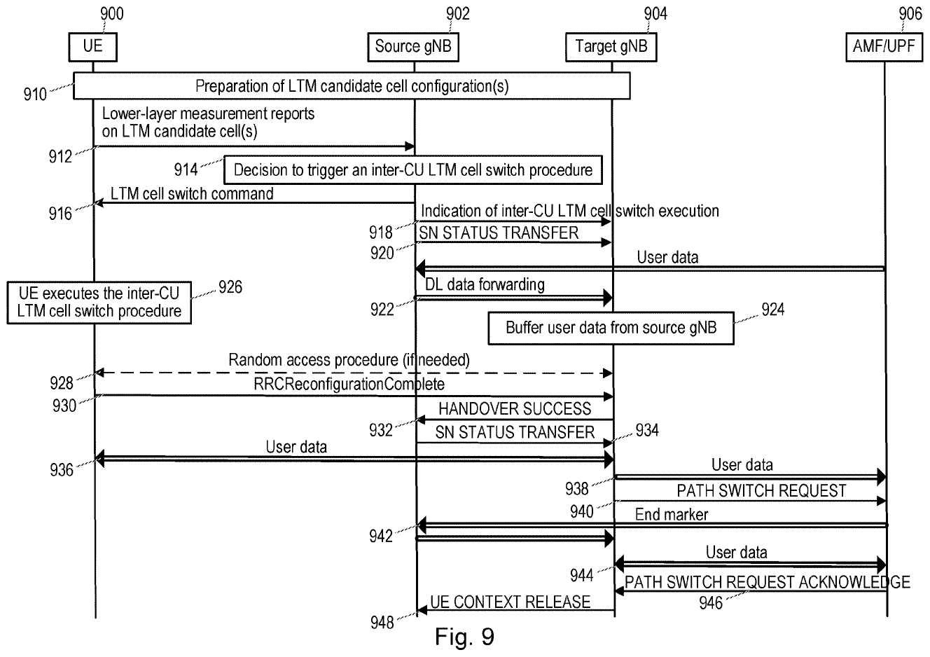

FIG. 9 illustrates a message sequence chart according to some embodiments. In this example, the UE 900 starts in a source cell controlled by a source gNB 902 and then executes an inter-CU LTM cell switch procedure to a target cell, controlled by a target gNB 904. During the execution, the source gNB indicates the execution of an inter-CU LTM cell switch procedure to the target gNB after the LTM cell switch command to the UE has been transmitted. The signalling also involves a 5G core network 906, comprising a user plane function (UPF) and an access and mobility management function (AMF).

Referring to FIG. 9, the main steps in this example are as follows:
Step 910. The network prepares one or multiple LTM candidate cell configuration and provides the LTM candidate cell configuration(s) to the UE 900. At least one of these LTM candidate cell configuration(s) is an inter-CU LTM candidate cell configuration.
Step 912. The UE 900 measures on the configured LTM candidate cells and transmits lower-layer measurement reports, such as CSI measurements, to the source gNB 902.
Step 914. The source gNB 902 decides to trigger an inter-CU LTM cell switch procedure to a target cell, in this example, a target cell controlled by the target gNB
Step 916. The source gNB 902 transmits an LTM cell switch command to the UE 900 to trigger the inter-CU LTM cell switch procedure. The LTM cell switch command contains an indication of an inter-CU LTM candidate cell configuration for the target cell.
Step 918. The source gNB 902 transmits an indication about the execution of an inter-CU LTM cell switch procedure to the target gNB 904. The indication may include one or more of the following information:
   LTM Candidate cell configuration ID
   Security key K_{gNB} key to be used by the target gNB, derived by source gNB 902 from the K_{gNB} key used in the source cell.

In one example, the target gNB 904 transmits, after reception of the indication, a response message to the source gNB 902.
Step 920. The source gNB 902 transmits an SN STATUS TRANSFER message to the target gNB 904 to convey the uplink PDCP SN receiver status and the downlink PDCP SN transmitter status of DRBs for which PDCP status preservation applies (i.e. for RLC AM). The uplink PDCP SN receiver status includes at least the PDCP SN of the first missing UL PDCP SDU and may include a bit map of the receive status of the out of sequence UL PDCP SDUs that the UE 900 needs to retransmit in the target cell, if any. The downlink PDCP SN transmitter status indicates the next PDCP SN that the target gNB 904 shall assign to new PDCP SDUs, not having a PDCP SN yet.
Step 922. The source gNB 902 starts forwarding downlink data, received from the UPF 906, to the target gNB 904.
Step 924. The target gNB 904 buffers the forwarded downlink data for later transmission to the UE 900 when it has arrived in the target cell.
Step 926. As response to the received LTM cell switch command, the UE 900 executes the inter-CU LTM cell switch procedure including applying the indicated inter-CU LTM candidate cell configuration, performing security key refresh and switching to the target cell.
Steps 928-930. The UE 900 transmits an LTM cell switch complete message, such as an RRCReconfigurationComplete message, in the target cell to the target gNB 904, after a potential random access procedure, according to the applied inter-CU LTM candidate cell configuration. The LTM cell switch complete message is ciphered and/or integrity protected based on the newly derived security keys, and is used to indicate to the target gNB 904 that the UE 900 has successfully performed the key refresh.
Steps 932-934. Upon reception of the LTM cell switch complete message from the UE 900, the target gNB 904 transmits, to the source gNB 902, a HANDOVER SUCCESS indicating the UE arrival in the target cell. The source gNB 902 transmits an SN STATUS TRANSFER to the target gNB 904.
Steps 936-938. The UE 900 starts transmitting, to the target gNB 904, uplink data and receives, from the target gNB 904, the earlier forwarded downlink data. The target gNB 904 forwards, to the UPF 906, the uplink data that is received from the UE 900.
Step 940. The target gNB 900 transmits a PATH SWITCH REQUEST message to the AMF 906 to trigger 5GC to switch the DL data path towards the target gNB 904 and to establish an NG-C interface instance towards the target gNB 904.
Step 942. 5GC switches the DL data path towards the target gNB 904. The UPF 906 sends one or more “end marker” packets on the old path to the source gNB 902 per PDU session/tunnel and then can release any U-plane/TNL resources towards the source gNB.
Step 944. When the target gNB 904 receives the end marker via the source gNB 902 it inserts the received, from the UPF, downlink data stream to the UE 900.
Step 946. The AMF transmits a PATH SWITCH REQUEST ACKNOWLEDGE message to the target gNB 904 to confirm that path switch has been completed.
Step 948. The target gNB 904 transmits a UE CONTEXT RELEASE message to the source gNB 902. The source gNB 902 can then release radio and C-plane related resources associated to the UE context.

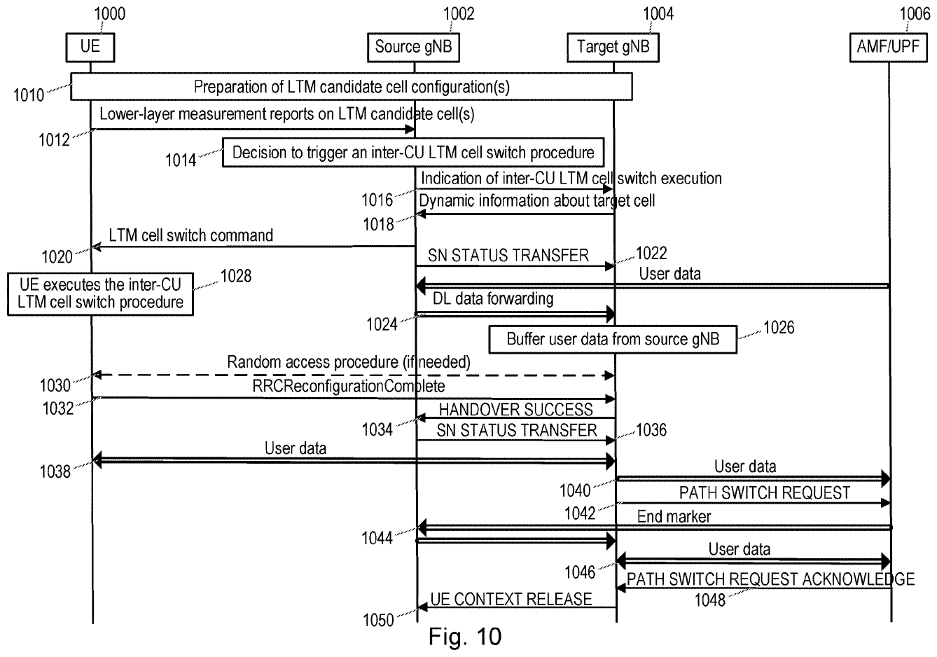

FIG. 10 illustrates a message sequence chart according to some embodiments. In this example, the UE 1000 starts in a source cell controlled by a source gNB 1002 and then executes an inter-CU LTM cell switch procedure to a target cell, controlled by a target gNB 1004. During the execution, the source gNB 1002 indicates the execution of an inter-CU LTM cell switch procedure to the target gNB 1004 before the LTM cell switch command to the UE 1000 has been transmitted and the target gNB 1004 provides some dynamic information about the target cell to be used by the source gNB 1002 before transmitting the LTM cell switch command. The signalling also involves a 5G core network 1006, comprising a user plane function (UPF) and an access and mobility management function (AMF).

Referring to FIG. 10, the main steps in this example are as follows:
Step 1010. The network prepares one or multiple LTM candidate cell configuration and provides the LTM candidate cell configuration(s) to the UE 1000. At least one of these LTM candidate cell configuration(s) is an inter-CU LTM candidate cell configuration.
Step 1012. The UE 1000 measures on the configured LTM candidate cells and transmits measurement reports, such lower-layer measurement reports, such as CSI measurements, to the source gNB 1002.
Step 1014. The source gNB 1002 decides to trigger an inter-CU LTM cell switch procedure to a target cell, in this example, a target cell controlled by the target gNB 1004.
Step 1016. The source gNB 1002 transmits an indication about the execution of an inter-CU LTM cell switch procedure to the target gNB 1004. The indication may include one or more of the following information:
   LTM Candidate cell configuration ID
   Security key K_{gNB} key to be used by the target gNB 1004, derived by source gNB 1002 from the K_{gNB} key used in the source cell.
Step 1018. In the response to the indication received from the source gNB 1002, the target gNB 1004 returns dynamic information about the target cell or beam, e.g. Timing advance information.
Step 1020. The source gNB 1002 transmits an LTM cell switch command to the UE 1000 to trigger the inter-CU LTM cell switch procedure. The LTM cell switch command contains an indication of the inter-CU LTM candidate cell configuration for the target cell and may also include any dynamic information about the target cell or beam received from the target gNB 1004.
Steps 1022 to 1050. Same as steps 920-948 in FIG. 9.

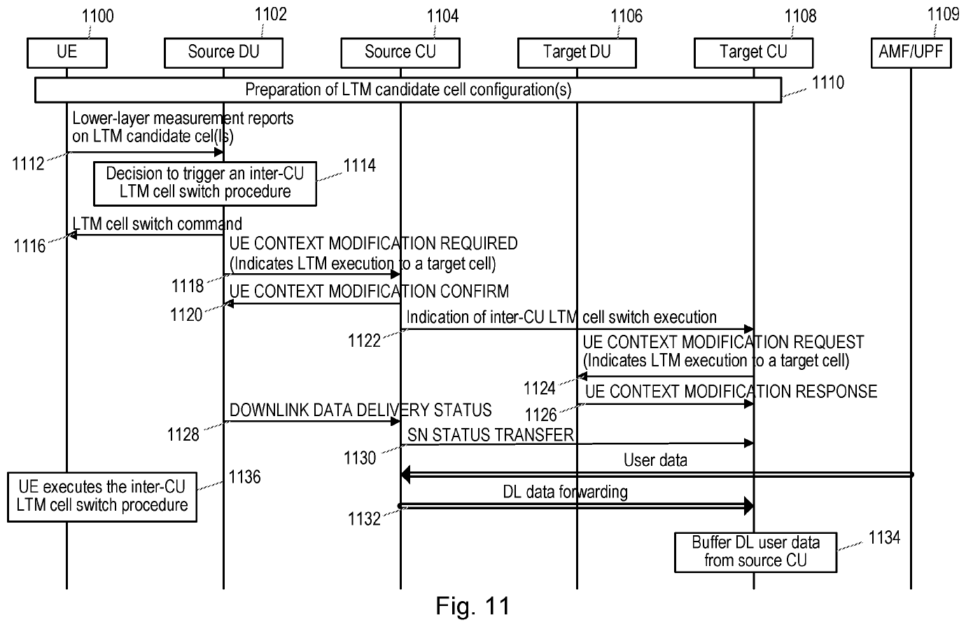

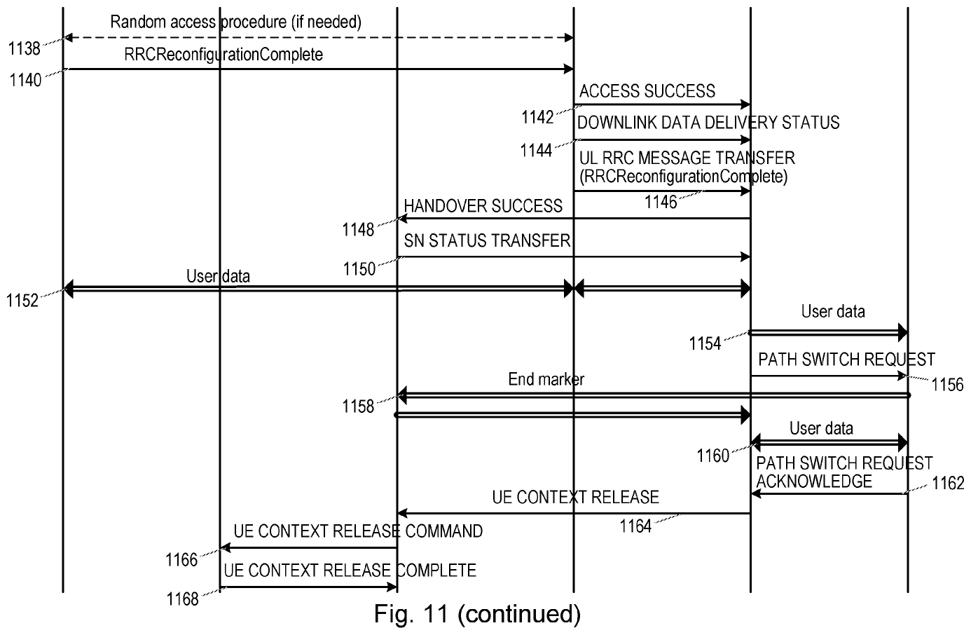

FIG. 11 illustrates a message sequence chart according to some embodiments. In this example, an inter-CU LTM cell switch procedure for a UE 1100 is executed where both the source gNB and target gNB uses a distributed CU/DU RAN architecture. That is, the source gNB comprises a source DU 1102 and a source CU 1104, and the target gNB comprises a target DU 1106 and a target CU 1108. The signalling also involves a 5G core network 1109, comprising a UPF and an AMF.

Referring to FIG. 11, the main steps in this example are as follows:
Step 1110. The network prepares one or multiple LTM candidate cell configuration and provides the LTM candidate cell configuration(s) to the UE 1100. At least one of these LTM candidate cell configuration(s) is an inter-CU LTM candidate cell configuration.
Step 1112. The UE 1100 measures on the configured LTM candidate cells and transits measurement reports, such lower-layer measurement reports, such as CSI measurements, to the source DU 1102.
Step 1114. The source DU 1102 decides to trigger an inter-CU LTM cell switch procedure to a target cell, in this example, a target cell controlled by the target DU 1106.
Step 1116. The source DU 1102 transmits an LTM cell switch command to the UE 1100 to trigger the inter-CU LTM cell switch procedure. The LTM cell switch command contains an indication of an inter-CU LTM candidate cell configuration for the target cell.
Step 1118. The source DU 1102 transmits an indication about the execution of an inter-CU LTM cell switch procedure to the source CU 1104, in e.g. a UE CONTEXT MODIFICATION REQUIRED message.
Step 1120-1122. The source CU 1104 acknowledges the information in an UE CONTEXT MODIFICATION CONFIRM message to the source DU 1102 and transmits an indication about the execution of an inter-CU LTM cell switch procedure to the target CU 1108 which includes indication of LTM target cell. In one alternative, the target CU 1108 transmits a response message to the source CU 1104.
Steps 1124-1126. The target CU 1108 informs the target DU 1106 about the execution of an inter-CU LTM cell switch procedure and the target DU 1106 acknowledges the information.
Steps 1128-1130. The source DU 1102 transmits a DL data delivery status frame to the source CU 1104 to inform the Source CU 1104 about the unsuccessfully transmitted downlink data to the UE 1100. The source CU 1104 then transmits an SN STATUS TRANSFER message to the target CU 1108 to convey the uplink PDCP SN receiver status and the downlink PDCP SN transmitter status of DRBs for which PDCP status preservation applies (i.e. for RLC AM). The uplink PDCP SN receiver status includes at least the PDCP SN of the first missing UL PDCP SDU and may include a bit map of the receive status of the out of sequence UL PDCP SDUs that the UE 1100 needs to retransmit in the target cell, if any. The downlink PDCP SN transmitter status indicates the next PDCP SN that the target CU 1108 shall assign to new PDCP SDUs, not having a PDCP SN yet.
Step 1132. The source CU 1104 starts forwarding downlink data, received from the UPF 1109, to the target CU 1108.
Step 1134. The target CU 1108 buffers the forwarded downlink data for later transmission to the UE 1100 when it has arrived in the target cell.
Step 1136. As response to the received an LTM cell switch command, the UE 1100 executes the inter-CU LTM cell switch procedure including applying the indicated inter-CU LTM candidate cell configuration, performing security key refresh and switching to the target cell.
Steps 1138-1140. The UE 1100 transmits an LTM cell switch complete message, such as an RRCReconfigurationComplete message, in the target cell to the target DU 1106, after a potential random access procedure, according to the applied inter-CU LTM candidate cell configuration.
Step 1142. The target DU 1106 transmits an ACCESS SUCCESS to the target CU 1108 to indicate the UE arrival in the target cell and
Step 1144. The target DU 1106 transmits a Downlink Data Delivery Status frame to the target CU 1108 to inform the target CU 1108.
Step 1146. The target DU 1106 forwards the LTM cell switch complete message in an UL RRC MESSAGE TRANSFER to the target CU 1108. The LTM cell switch complete message is ciphered and/or integrity protected based on the newly derived security keys, and is used to indicate to the target CU 1108 that the UE 1100 has successfully performed the key refresh.
Step 1148. The target CU 1108 transmits, to the source CU 1104, a HANDOVER SUCCESS indicating the UE arrival in the target cell.
Step 1150. The source CU 1104 transmits an SN STATUS TRANSFER to the target CU 1108.
Steps 1152-1154. The UE 1100 starts transmitting, to the target DU 1106, uplink data and receives, from the target DU 1106, the earlier forwarded downlink data. The target DU 1106 forwards uplink data to the target CU 1108 and receives downlink data from the target CU 1108. The target CU 1108 forwards, to the UPF 1109, the uplink data that is received from the target CU 1108.
Step 1156. The target CU 1108 transmits a PATH SWITCH REQUEST message to the AMF 1109 to trigger 5GC to switch the DL data path towards the target CU 1108 and to establish an NG-C interface instance towards the target CU 1108.
Step 1158. 5GC switches the DL data path towards the target CU 1108. The UPF 1109 sends one or more “end marker” packets on the old path to the source CU 1104 per PDU session/tunnel and then can release any U-plane/TNL resources towards the source CU 1104.
Step 1160. When the target CU 1108 receives the end marker via the source CU 1104 it inserts the received, from the UPF 1109, downlink data stream to the UE 1100.
Step 1162. The AMF 1109 transmits a PATH SWITCH REQUEST ACKNOWLEDGE message to the target CU 1108 to confirm that path switch has been completed.
Steps 1164-1168. The target CU 1108 transmits a UE CONTEXT RELEASE message to the source CU 1104. The source CU 1104 can then release radio and C-plane related resources associated to the UE context. A part of this it requests the source DU 1102 to release the UE context.

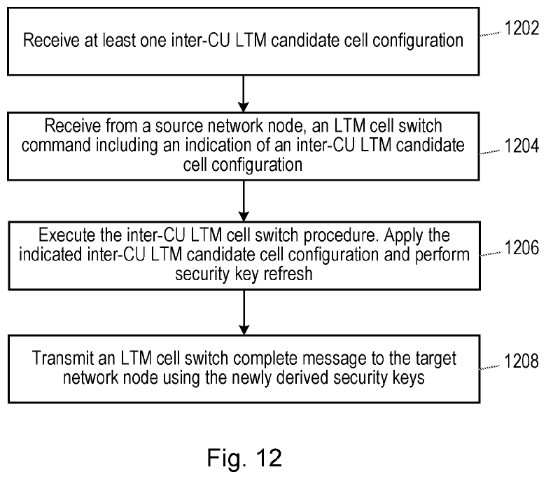

FIG. 12 illustrates a flow chart with the main steps performed by the UE according to some embodiments.

Referring to FIG. 12, the main steps performed by the UE in this example are as follows.
Step 1202. The UE receives one or multiple LTM candidate cell configuration(s) from the network. At least one of these LTM candidate cell configuration(s) is an inter-CU LTM candidate cell configuration.
Step 1204. The UE receives an LTM cell switch command to trigger an inter-CU LTM cell switch procedure. The LTM cell switch command contains an indication of the inter-CU LTM candidate cell configuration for a target cell.
Step 1206. As response to the LTM cell switch command, the UE executes the inter-CU LTM cell switch procedure, including applying the indicated inter-CU LTM candidate cell configuration, performing security key refresh and switching to the target cell.
Step 1208. The UE transmits an LTM cell switch complete message, such as an RRCReconfigurationComplete message, in the target cell according to the applied inter-CU LTM candidate cell configuration. The LTM cell switch complete message is ciphered and/or integrity protected based on the newly derived security keys, and is used to indicate to the network in the target cell that the UE has successfully performed the key refresh.

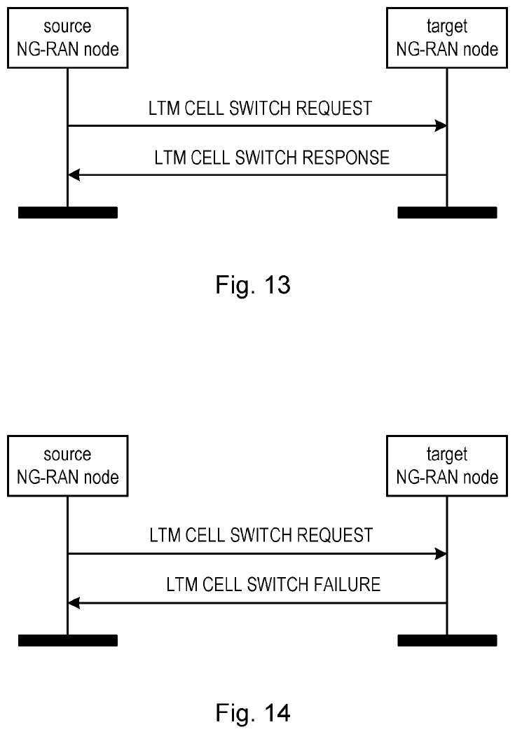

Below an implementation in the 3GPP XnAP specification, TS 38.423 v17.4.0, is illustrated according to some embodiments. The implementation involves the procedures shown in FIGS. 13 and 14, which illustrate signaling between a source NG-RAN node and a target NG-RAN node, for successful operation and unsuccessful operation respectively.

### 8.2.x LTM Cell Switch

### 8.2.x.1 General

This procedure is used to indicate to an NG-RAN node execution of an L1/L2 triggered mobility.

The procedure uses UE-associated signalling.

### 8.2.1.2 Successful Operation

The source NG-RAN node initiates the procedure by sending the LTM CELL SWITCH REQUEST message to the target NG-RAN node. When the source NG-RAN node sends the LTM CELL SWITCH REQUEST message, it shall start the timer TXnRELOCprep.

If the Security Key IE is contained in the LTM CELL SWITCH REQUEST message, the target NG-RAN node shall use it as described in TS 38.300.

If the LTM Execution Query IE is included in the LTM CELL SWITCH REQUEST message, the target NG-RAN node shall understand that it needs to include information about the target cell in the LTM Execution Information IE in the LTM CELL SWITCH RESPONSE message.

### 8.x.1.3 Unsuccessful Operation

If the target NG-RAN node cannot proceed with the LTM cell switch or if the Timer . . . expires, the target NG-RAN node shall send the LTM CELL SWITCH FAILURE message to the source NG-RAN node. The message shall contain the Cause IE with an appropriate value.

Text omitted.

### 9.x.1.1 LTM CELL SWITCH REQUEST

This message is sent by the source NG-RAN node to the target NG-RAN node to indicate execution of L1/L2 triggered mobility.
Direction: source NG-RAN node→target NG-RAN node.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| Source NG-RAN node | M | | NG-RAN node UE | Allocated at the | YES | reject |
| UE XnAP ID reference | | | XnAP ID | source NG-RAN | | |
| | | | 9.2.3.16 | node | | |
| Target Cell Global ID | M | | 9.2.3.25 | Includes either an | YES | reject |
| | | | | E-UTRA CGI or | | |
| | | | | an NR CGI | | |
| Security Key | O | | OCTET STRING | | YES | ignore |
| LTM Execution | O | | ENUMERATED | | YES | ignore |
| Indication | | | (true, . . . , false) | | | |

### 9.x.1.2 LTM Cell SWITCH REQUEST ACKNOWLEDGE

This message is sent by the target NG-RAN node to acknowledge to the source NG-RAN node the execution of L1/L2 triggered mobility.
Direction: target NG-RAN node→source NG-RAN node.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| Source NG-RAN node | M | | NG-RAN node | Allocated at the | YES | ignore |
| UE XnAP ID | | | UE XnAP ID | source NG-RAN | | |
| | | | 9.2.3.16 | node | | |
| Target NG-RAN node UE | M | | NG-RAN node | Allocated at the | YES | ignore |
| XnAP ID | | | UE XnAP ID | target NG-RAN | | |
| | | | 9.2.3.16 | node | | |
| LTM Execution | O | | OCTET | Container | YES | ignore |
| Information | | | STRING | carrying | | |
| | | | | information about | | |
| | | | | the target cell | | |
| | | | | during LTM cell | | |
| | | | | switch execution. | | |
| | | | | FFS | | |

### 9.x.1.3 LTM CELL SWITCH FAILURE

This message is sent by the target NG-RAN node to inform the source NG-RAN node that the LTM Cell Switch has failed.
Direction: target NG-RAN node→source NG-RAN node.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| Source NG-RAN node | M | | NG-RAN node UE | Allocated at | YES | ignore |
| UE XnAP ID | | | XnAP ID | the source | | |
| | | | 9.2.3.16 | NG-RAN | | |
| | | | | node | | |
| Cause | M | | 9.2.3.2 | | YES | ignore |
| Criticality Diagnostics | O | | 9.2.3.3 | | YES | ignore |

### 9.1.1.xxx LTM CELL SWITCH SUCCESS

This message is sent by the target NG-RAN node to the source NG-RAN node to indicate the successful access of the UE toward the target NG-RAN node for LTM operation.
Direction: target NG-RAN node→source NG-RAN node.

| | | | | Semantics | | Assigned |
|---|---|---|---|---|---|---|
| IE/Group Name | Presence | Range | IE type and reference | description | Criticality | Criticality |
| Message Type | M | | 9.2.3.1 | | YES | ignore |
| Source NG-RAN | M | | NG-RAN node UE | Allocated at | YES | reject |
| node UE XnAP ID | | | XnAP ID | the source | | |
| | | | 9.2.3.16 | NG-RAN | | |
| | | | | node. | | |
| Target NG-RAN | M | | NG-RAN node UE | Allocated at | YES | reject |
| node UE XnAP ID | | | XnAP ID | the target | | |
| | | | 9.2.3.16 | NG-RAN | | |
| | | | | node. | | |
| Requested Target | M | | Target Cell Global ID | Target cell | YES | reject |
| Cell ID | | | 9.2.3.25 | indicated in | | |
| | | | | the | | |
| | | | | corresponding | | |
| | | | | LTM Cell | | |
| | | | | Switch | | |
| | | | | preparation | | |
| | | | | procedure | | |

FIG. 15 shows an example of a communication system 1500 in accordance with some embodiments.

In the example, the communication system 1500 includes a telecommunication network 1502 that includes an access network 1504, such as a radio access network (RAN), and a core network 1506, which includes one or more core network nodes 1508. The access network 1504 includes one or more access network nodes, such as network nodes 1510a and 1510b (one or more of which may be generally referred to as network nodes 1510), or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 1502 includes one or more Open-RAN (ORAN) network nodes. An ORAN network node is a node in the telecommunication network 1502 that supports an ORAN specification (e.g., a specification published by the O-RAN Alliance, or any similar organization) and may operate alone or together with other nodes to implement one or more functionalities of any node in the telecommunication network 1502, including one or more network nodes 1510 and/or core network nodes 1508.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 1510 facilitate direct or indirect connection of user equipment (UE), such as by connecting UEs 1512a, 1512b, 1512c, and 1512d (one or more of which may be generally referred to as UEs 1512) to the core network 1506 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1500 may include any number of wired or wireless networks, network nodes, UEs, and/or any other components or systems that may facilitate or participate in the communication of data and/or signals whether via wired or wireless connections. The communication system 1500 may include and/or interface with any type of communication, telecommunication, data, cellular, radio network, and/or other similar type of system.

The UEs 1512 may be any of a wide variety of communication devices, including wireless devices arranged, configured, and/or operable to communicate wirelessly with the network nodes 1510 and other communication devices. Similarly, the network nodes 1510 are arranged, capable, configured, and/or operable to communicate directly or indirectly with the UEs 1512 and/or with other network nodes or equipment in the telecommunication network 1502 to enable and/or provide network access, such as wireless network access, and/or to perform other functions, such as administration in the telecommunication network 1502.

In the depicted example, the core network 1506 connects the network nodes 1510 to one or more hosts, such as host 1516. These connections may be direct or indirect via one or more intermediary networks or devices. In other examples, network nodes may be directly coupled to hosts. The core network 1506 includes one more core network nodes (e.g., core network node 1508) that are structured with hardware and software components. Features of these components may be substantially similar to those described with respect to the UEs, network nodes, and/or hosts, such that the descriptions thereof are generally applicable to the corresponding components of the core network node 1508. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), Policy Control Function (PCF) and/or a User Plane Function (UPF).

The host 1516 may be under the ownership or control of a service provider other than an operator or provider of the access network 1504 and/or the telecommunication network 1502, and may be operated by the service provider or on behalf of the service provider. The host 1516 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1500 of FIG. 15 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1502 is a cellular network that implements 3GPP standardized features. Accordingly, the telecommunications network 1502 may support network slicing to provide different logical networks to different devices that are connected to the telecommunication network 1502. For example, the telecommunications network 1502 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1512 are configured to transmit and/or receive information without direct human interaction. For instance, a UE may be designed to transmit information to the access network 1504 on a predetermined schedule, when triggered by an internal or external event, or in response to requests from the access network 1504. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example illustrated in FIG. 15, the hub 1514 communicates with the access network 1504 to facilitate indirect communication between one or more UEs (e.g., UE 1512c and/or 1512d) and network nodes (e.g., network node 1510b). In some examples, the hub 1514 may be a controller, router, a content source and analytics node, or any of the other communication devices described herein regarding UEs. For example, the hub 1514 may be a broadband router enabling access to the core network 1506 for the UEs. As another example, the hub 1514 may be a controller that sends commands or instructions to one or more actuators in the UEs. Commands or instructions may be received from the UEs, network nodes 1510, or by executable code, script, process, or other instructions in the hub 1514. As another example, the hub 1514 may be a data collector that acts as temporary storage for UE data and, in some embodiments, may perform analysis or other processing of the data. As another example, the hub 1514 may be a content source. For example, for a UE that is a VR headset, display, loudspeaker or other media delivery device, the hub 1514 may retrieve VR assets, video, audio, or other media or data related to sensory information via a network node, which the hub 1514 then provides to the UE either directly, after performing local processing, and/or after adding additional local content. In still another example, the hub 1514 acts as a proxy server or orchestrator for the UEs, in particular if one or more of the UEs are low energy IoT devices.

The hub 1514 may have a constant/persistent or intermittent connection to the network node 1510b. The hub 1514 may also allow for a different communication scheme and/or schedule between the hub 1514 and UEs (e.g., UE 1512c and/or 1512d), and between the hub 1514 and the core network 1506. In other examples, the hub 1514 is connected to the core network 1506 and/or one or more UEs via a wired connection. Moreover, the hub 1514 may be configured to connect to an M2M service provider over the access network 1504 and/or to another UE over a direct connection. In some scenarios, UEs may establish a wireless connection with the network nodes 1510 while still connected via the hub 1514 via a wired or wireless connection. In some embodiments, the hub 1514 may be a dedicated hub—that is, a hub whose primary function is to route communications to/from the UEs from/to the network node 1510b. In other embodiments, the hub 1514 may be a non-dedicated hub—that is, a device which is capable of operating to route communications between the UEs and network node 1510b, but which is additionally capable of operating as a communication start and/or end point for certain data channels.

FIG. 16 shows a UE 1600 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1600 includes processing circuitry 1602 that is operatively coupled via a bus 1604 to an input/output interface 1606, a power source 1608, a memory 1610, a communication interface 1612, and/or any other component, or any combination thereof. Certain UEs may utilize all or a subset of the components shown in FIG. 16. The level of integration between the components may vary from one UE to another UE. Further, certain UEs may contain multiple instances of a component, such as multiple processors, memories, transceivers, transmitters, receivers, etc.

The processing circuitry 1602 is configured to process instructions and data and may be configured to implement any sequential state machine operative to execute instructions stored as machine-readable computer programs in the memory 1610. The processing circuitry 1602 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1602 may include multiple central processing units (CPUs). The processing circuitry 1602 may be operable to provide, either alone or in conjunction with other UE 1600 components, such as the memory 1610, UE 1600 functionality. For example, the processing circuitry 1602 may be configured to cause the UE 1602 to perform the methods as described with reference to FIGS. 4 and 8.

In the example, the input/output interface 1606 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1600. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1608 is structured as a battery or battery pack. Other types of power sources, such as an external power source (e.g., an electricity outlet), photovoltaic device, or power cell, may be used. The power source 1608 may further include power circuitry for delivering power from the power source 1608 itself, and/or an external power source, to the various parts of the UE 1600 via input circuitry or an interface such as an electrical power cable. Delivering power may be, for example, for charging of the power source 1608. Power circuitry may perform any formatting, converting, or other modification to the power from the power source 1608 to make the power suitable for the respective components of the UE 1600 to which power is supplied.

The memory 1610 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1610 includes one or more application programs 1614, such as an operating system, web browser application, a widget, gadget engine, or other application, and corresponding data 1616. The memory 1610 may store, for use by the UE 1600, any of a variety of various operating systems or combinations of operating systems.

The memory 1610 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1610 may allow the UE 1600 to access instructions, application programs and the like, stored on transitory or non-transitory memory media, to off-load data, or to upload data. An article of manufacture, such as one utilizing a communication system may be tangibly embodied as or in the memory 1610, which may be or comprise a device-readable storage medium.

The processing circuitry 1602 may be configured to communicate with an access network or other network using the communication interface 1612. The communication interface 1612 may comprise one or more communication subsystems and may include or be communicatively coupled to an antenna 1622. The communication interface 1612 may include one or more transceivers used to communicate, such as by communicating with one or more remote transceivers of another device capable of wireless communication (e.g., another UE or a network node in an access network). Each transceiver may include a transmitter 1618 and/or a receiver 1620 appropriate to provide network communications (e.g., optical, electrical, frequency allocations, and so forth). Moreover, the transmitter 1618 and receiver 1620 may be coupled to one or more antennas (e.g., antenna 1622) and may share circuit components, software or firmware, or alternatively be implemented separately.

In some embodiments, communication functions of the communication interface 1612 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1612, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE 1600 shown in FIG. 16.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 17 shows a network node 1700 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1700 includes processing circuitry 1702, a memory 1704, a communication interface 1706, and a power source 1708, and/or any other component, or any combination thereof. The network node 1700 may be composed of multiple physically separate components (e.g., a NodeB component and a RNC component, or a BTS component and a BSC component, etc.), which may each have their own respective components. In certain scenarios in which the network node 1700 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1700 may be configured to support multiple radio access technologies (RATs). In such embodiments, some components may be duplicated (e.g., separate memory 1704 for different RATs) and some components may be reused (e.g., a same antenna 1710 may be shared by different RATs). The network node 1700 may also include multiple sets of the various illustrated components for different wireless technologies integrated into network node 1700, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1700.

The processing circuitry 1702 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1700 components, such as the memory 1704, network node 1700 functionality. For example, the processing circuitry 1702 may be configured to cause the network node to perform the methods as described with reference to FIGS. 5 and 6.

In some embodiments, the processing circuitry 1702 includes a system on a chip (SOC). In some embodiments, the processing circuitry 1702 includes one or more of radio frequency (RF) transceiver circuitry 1712 and baseband processing circuitry 1714. In some embodiments, the radio frequency (RF) transceiver circuitry 1712 and the baseband processing circuitry 1714 may be on separate chips (or sets of chips), boards, or units, such as radio units and digital units. In alternative embodiments, part or all of RF transceiver circuitry 1712 and baseband processing circuitry 1714 may be on the same chip or set of chips, boards, or units.

The memory 1704 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1702. The memory 1704 may store any suitable instructions, data, or information, including a computer program, software, an application including one or more of logic, rules, code, tables, and/or other instructions capable of being executed by the processing circuitry 1702 and utilized by the network node 1700. The memory 1704 may be used to store any calculations made by the processing circuitry 1702 and/or any data received via the communication interface 1706. In some embodiments, the processing circuitry 1702 and memory 1704 is integrated.

The communication interface 1706 is used in wired or wireless communication of signaling and/or data between a network node, access network, and/or UE. As illustrated, the communication interface 1706 comprises port(s)/terminal(s) 1716 to send and receive data, for example to and from a network over a wired connection. The communication interface 1706 also includes radio front-end circuitry 1718 that may be coupled to, or in certain embodiments a part of, the antenna 1710. Radio front-end circuitry 1718 comprises filters 1720 and amplifiers 1722. The radio front-end circuitry 1718 may be connected to an antenna 1710 and processing circuitry 1702. The radio front-end circuitry may be configured to condition signals communicated between antenna 1710 and processing circuitry 1702. The radio front-end circuitry 1718 may receive digital data that is to be sent out to other network nodes or UEs via a wireless connection. The radio front-end circuitry 1718 may convert the digital data into a radio signal having the appropriate channel and bandwidth parameters using a combination of filters 1720 and/or amplifiers 1722. The radio signal may then be transmitted via the antenna 1710. Similarly, when receiving data, the antenna 1710 may collect radio signals which are then converted into digital data by the radio front-end circuitry 1718. The digital data may be passed to the processing circuitry 1702. In other embodiments, the communication interface may comprise different components and/or different combinations of components.

In certain alternative embodiments, the network node 1700 does not include separate radio front-end circuitry 1718, instead, the processing circuitry 1702 includes radio front-end circuitry and is connected to the antenna 1710. Similarly, in some embodiments, all or some of the RF transceiver circuitry 1712 is part of the communication interface 1706. In still other embodiments, the communication interface 1706 includes one or more ports or terminals 1716, the radio front-end circuitry 1718, and the RF transceiver circuitry 1712, as part of a radio unit (not shown), and the communication interface 1706 communicates with the baseband processing circuitry 1714, which is part of a digital unit (not shown).

The antenna 1710 may include one or more antennas, or antenna arrays, configured to send and/or receive wireless signals. The antenna 1710 may be coupled to the radio front-end circuitry 1718 and may be any type of antenna capable of transmitting and receiving data and/or signals wirelessly. In certain embodiments, the antenna 1710 is separate from the network node 1700 and connectable to the network node 1700 through an interface or port.

The antenna 1710, communication interface 1706, and/or the processing circuitry 1702 may be configured to perform any receiving operations and/or certain obtaining operations described herein as being performed by the network node. Any information, data and/or signals may be received from a UE, another network node and/or any other network equipment. Similarly, the antenna 1710, the communication interface 1706, and/or the processing circuitry 1702 may be configured to perform any transmitting operations described herein as being performed by the network node. Any information, data and/or signals may be transmitted to a UE, another network node and/or any other network equipment.

The power source 1708 provides power to the various components of network node 1700 in a form suitable for the respective components (e.g., at a voltage and current level needed for each respective component). The power source 1708 may further comprise, or be coupled to, power management circuitry to supply the components of the network node 1700 with power for performing the functionality described herein. For example, the network node 1700 may be connectable to an external power source (e.g., the power grid, an electricity outlet) via an input circuitry or interface such as an electrical cable, whereby the external power source supplies power to power circuitry of the power source 1708. As a further example, the power source 1708 may comprise a source of power in the form of a battery or battery pack which is connected to, or integrated in, power circuitry. The battery may provide backup power should the external power source fail.

Embodiments of the network node 1700 may include additional components beyond those shown in FIG. 17 for providing certain aspects of the network node's functionality, including any of the functionality described herein and/or any functionality necessary to support the subject matter described herein. For example, the network node 1700 may include user interface equipment to allow input of information into the network node 1700 and to allow output of information from the network node 1700. This may allow a user to perform diagnostic, maintenance, repair, and other administrative functions for the network node 1700.

FIG. 21 shows a network node 2100 in accordance with some embodiments. As used herein, network node refers to equipment capable, configured, arranged and/or operable to communicate directly or indirectly with a UE and/or with other network nodes or equipment, in a telecommunication network. The network node 2100 may be operable as a core network node, a core network function or, more generally, a core network entity, such as the core network node 1508 described above with respect to FIG. 15). Examples of network nodes in this context include core network entities such as one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), Policy Control Function (PCF) and/or a User Plane Function (UPF).

The network node 2100 includes processing circuitry 2102, a memory 2104, a communication interface 2106, and a power source 2108, and/or any other component, or any combination thereof. The network node 2100 may be composed of multiple physically separate components, which may each have their own respective components. In certain scenarios in which the network node 2100 comprises multiple separate components, one or more of the separate components may be shared among several network nodes.

The processing circuitry 2102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2100 components, such as the memory 2104, network node 2100 functionality. For example, the processing circuitry 2102 may be configured to cause the network node to perform the methods as described with reference to FIG. 7.

The memory 2104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 2102. The memory 2104 may store any suitable instructions, data, or information, including a computer program, software, an application including one or more of logic, rules, code, tables, and/or other instructions capable of being executed by the processing circuitry 2102 and utilized by the network node 2100. The memory 2104 may be used to store any calculations made by the processing circuitry 2102 and/or any data received via the communication interface 2106. In some embodiments, the processing circuitry 2102 and memory 2104 is integrated.

The communication interface 2106 is used in wired or wireless communication of signaling and/or data between a network node, access network, and/or UE.

The power source 2108 provides power to the various components of network node 2100 in a form suitable for the respective components (e.g., at a voltage and current level needed for each respective component). The power source 2108 may further comprise, or be coupled to, power management circuitry to supply the components of the network node 2100 with power for performing the functionality described herein. For example, the network node 2100 may be connectable to an external power source (e.g., the power grid, an electricity outlet) via an input circuitry or interface such as an electrical cable, whereby the external power source supplies power to power circuitry of the power source 2108. As a further example, the power source 2108 may comprise a source of power in the form of a battery or battery pack which is connected to, or integrated in, power circuitry. The battery may provide backup power should the external power source fail.

Embodiments of the network node 2100 may include additional components beyond those shown in FIG. 21 for providing certain aspects of the network node's functionality, including any of the functionality described herein and/or any functionality necessary to support the subject matter described herein. For example, the network node 2100 may include user interface equipment to allow input of information into the network node 2100 and to allow output of information from the network node 2100. This may allow a user to perform diagnostic, maintenance, repair, and other administrative functions for the network node 2100.

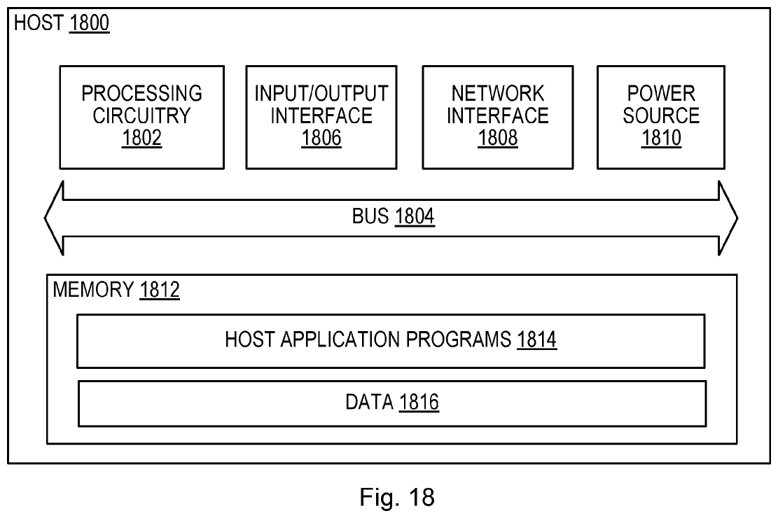

FIG. 18 is a block diagram of a host 1800, which may be an embodiment of the host 1516 of FIG. 15, in accordance with various aspects described herein. As used herein, the host 1800 may be or comprise various combinations hardware and/or software, including a standalone server, a blade server, a cloud-implemented server, a distributed server, a virtual machine, container, or processing resources in a server farm. The host 1800 may provide one or more services to one or more UEs.

The host 1800 includes processing circuitry 1802 that is operatively coupled via a bus 1804 to an input/output interface 1806, a network interface 1808, a power source 1810, and a memory 1812. Other components may be included in other embodiments. Features of these components may be substantially similar to those described with respect to the devices of previous figures, such as FIGS. 16 and 17, such that the descriptions thereof are generally applicable to the corresponding components of host 1800.

The memory 1812 may include one or more computer programs including one or more host application programs 1814 and data 1816, which may include user data, e.g., data generated by a UE for the host 1800 or data generated by the host 1800 for a UE. Embodiments of the host 1800 may utilize only a subset or all of the components shown. The host application programs 1814 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1814 may also provide for user authentication and licensing checks and may periodically report health, routes, and content availability to a central node, such as a device in or on the edge of a core network. Accordingly, the host 1800 may select and/or indicate a different host for over-the-top services for a UE. The host application programs 1814 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

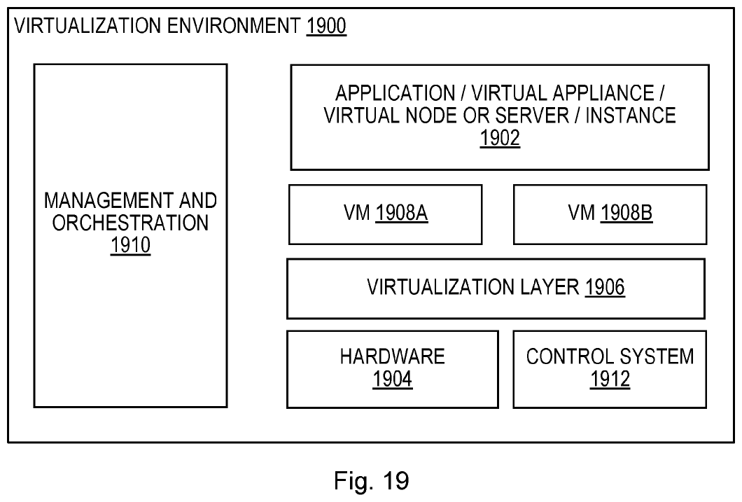

FIG. 19 is a block diagram illustrating a virtualization environment 1900 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1900 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1900 includes components defined by the O-RAN Alliance, such as an O-Cloud environment orchestrated by a Service Management and Orchestration Framework via an O-2 interface.

Applications 1902 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1906 (also referred to as hypervisors or virtual machine monitors (VMMs)), provide VMs 1908a and 1908b (one or more of which may be generally referred to as VMs 1908), and/or perform any of the functions, features and/or benefits described in relation with some embodiments described herein. The virtualization layer 1906 may present a virtual operating platform that appears like networking hardware to the VMs 1908.

The VMs 1908 comprise virtual processing, virtual memory, virtual networking or interface and virtual storage, and may be run by a corresponding virtualization layer 1906. Different embodiments of the instance of a virtual appliance 1902 may be implemented on one or more of VMs 1908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1908 may be a software implementation of a physical machine that runs programs as if they were executing on a physical, non-virtualized machine. Each of the VMs 1908, and that part of hardware 1904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1908 on top of the hardware 1904 and corresponds to the application 1902.

Hardware 1904 may be implemented in a standalone network node with generic or specific components. Hardware 1904 may implement some functions via virtualization. Alternatively, hardware 1904 may be part of a larger cluster of hardware (e.g. such as in a data center or CPE) where many hardware nodes work together and are managed via management and orchestration 1910, which, among others, oversees lifecycle management of applications 1902. In some embodiments, hardware 1904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1912 which may alternatively be used for communication between hardware nodes and radio units.

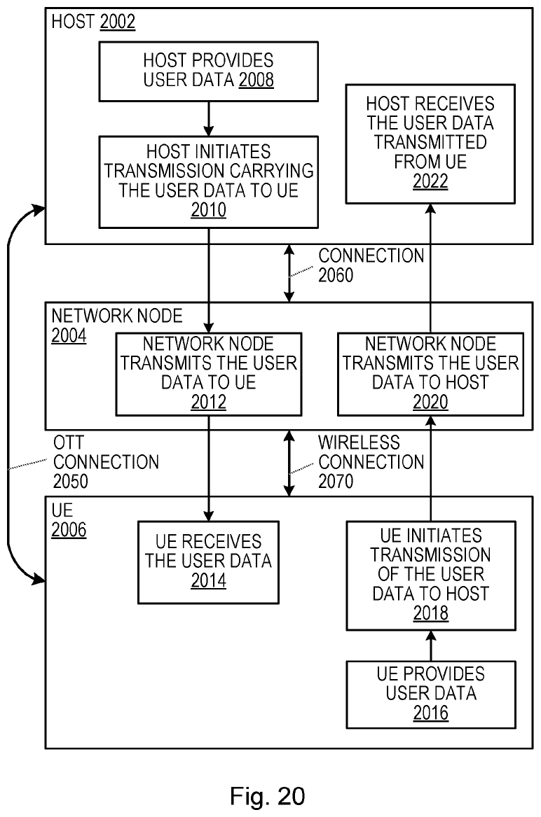

FIG. 20 shows a communication diagram of a host 2002 communicating via a network node 2004 with a UE 2006 over a partially wireless connection in accordance with some embodiments. Example implementations, in accordance with various embodiments, of the UE (such as a UE 1512a of FIG. 15 and/or UE 1600 of FIG. 16), network node (such as network node 1510a of FIG. 15 and/or network node 1700 of FIG. 17), and host (such as host 1516 of FIG. 15 and/or host 1800 of FIG. 18) discussed in the preceding paragraphs will now be described with reference to FIG. 20.

Like host 1800, embodiments of host 2002 include hardware, such as a communication interface, processing circuitry, and memory. The host 2002 also includes software, which is stored in or accessible by the host 2002 and executable by the processing circuitry. The software includes a host application that may be operable to provide a service to a remote user, such as the UE 2006 connecting via an over-the-top (OTT) connection 2050 extending between the UE 2006 and host 2002. In providing the service to the remote user, a host application may provide user data which is transmitted using the OTT connection 2050.

The network node 2004 includes hardware enabling it to communicate with the host 2002 and UE 2006. The connection 2060 may be direct or pass through a core network (like core network 1506 of FIG. 15) and/or one or more other intermediate networks, such as one or more public, private, or hosted networks. For example, an intermediate network may be a backbone network or the Internet.

The UE 2006 includes hardware and software, which is stored in or accessible by UE 2006 and executable by the UE's processing circuitry. The software includes a client application, such as a web browser or operator-specific “app” that may be operable to provide a service to a human or non-human user via UE 2006 with the support of the host 2002. In the host 2002, an executing host application may communicate with the executing client application via the OTT connection 2050 terminating at the UE 2006 and host 2002. In providing the service to the user, the UE's client application may receive request data from the host's host application and provide user data in response to the request data. The OTT connection 2050 may transfer both the request data and the user data. The UE's client application may interact with the user to generate the user data that it provides to the host application through the OTT connection 2050.

The OTT connection 2050 may extend via a connection 2060 between the host 2002 and the network node 2004 and via a wireless connection 2070 between the network node 2004 and the UE 2006 to provide the connection between the host 2002 and the UE 2006. The connection 2060 and wireless connection 2070, over which the OTT connection 2050 may be provided, have been drawn abstractly to illustrate the communication between the host 2002 and the UE 2006 via the network node 2004, without explicit reference to any intermediary devices and the precise routing of messages via these devices.

As an example of transmitting data via the OTT connection 2050, in step 2008, the host 2002 provides user data, which may be performed by executing a host application. In some embodiments, the user data is associated with a particular human user interacting with the UE 2006. In other embodiments, the user data is associated with a UE 2006 that shares data with the host 2002 without explicit human interaction. In step 2010, the host 2002 initiates a transmission carrying the user data towards the UE 2006. The host 2002 may initiate the transmission responsive to a request transmitted by the UE 2006. The request may be caused by human interaction with the UE 2006 or by operation of the client application executing on the UE 2006. The transmission may pass via the network node 2004, in accordance with the teachings of the embodiments described throughout this disclosure. Accordingly, in step 2012, the network node 2004 transmits to the UE 2006 the user data that was carried in the transmission that the host 2002 initiated, in accordance with the teachings of the embodiments described throughout this disclosure. In step 2014, the UE 2006 receives the user data carried in the transmission, which may be performed by a client application executed on the UE 2006 associated with the host application executed by the host 2002.

In some examples, the UE 2006 executes a client application which provides user data to the host 2002. The user data may be provided in reaction or response to the data received from the host 2002. Accordingly, in step 2016, the UE 2006 may provide user data, which may be performed by executing the client application. In providing the user data, the client application may further consider user input received from the user via an input/output interface of the UE 2006. Regardless of the specific manner in which the user data was provided, the UE 2006 initiates, in step 2018, transmission of the user data towards the host 2002 via the network node 2004. In step 2020, in accordance with the teachings of the embodiments described throughout this disclosure, the network node 2004 receives user data from the UE 2006 and initiates transmission of the received user data towards the host 2002. In step 2022, the host 2002 receives the user data carried in the transmission initiated by the UE 2006.

One or more of the various embodiments improve the performance of OTT services provided to the UE 2006 using the OTT connection 2050, in which the wireless connection 2070 forms the last segment.

In an example scenario, factory status information may be collected and analyzed by the host 2002. As another example, the host 2002 may process audio and video data which may have been retrieved from a UE for use in creating maps. As another example, the host 2002 may collect and analyze real-time data to assist in controlling vehicle congestion (e.g., controlling traffic lights). As another example, the host 2002 may store surveillance video uploaded by a UE. As another example, the host 2002 may store or control access to media content such as video, audio, VR or AR which it can broadcast, multicast or unicast to UEs. As other examples, the host 2002 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2050 between the host 2002 and UE 2006, in response to variations in the measurement results. The measurement procedure and/or the network functionality for reconfiguring the OTT connection may be implemented in software and hardware of the host 2002 and/or UE 2006. In some embodiments, sensors (not shown) may be deployed in or in association with other devices through which the OTT connection 2050 passes; the sensors may participate in the measurement procedure by supplying values of the monitored quantities exemplified above, or supplying values of other physical quantities from which software may compute or estimate the monitored quantities. The reconfiguring of the OTT connection 2050 may include message format, retransmission settings, preferred routing etc.; the reconfiguring need not directly alter the operation of the network node 2004. Such procedures and functionalities may be known and practiced in the art. In certain embodiments, measurements may involve proprietary UE signaling that facilitates measurements of throughput, propagation times, latency and the like, by the host 2002. The measurements may be implemented in that software causes messages to be transmitted, in particular empty or ‘dummy’ messages, using the OTT connection 2050 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The following numbered statements set out embodiments of the disclosure.

### Group A Embodiments

1. A method performed by a user equipment, the method comprising:
   receiving, from a network node, a configuration for use in connecting to and/or communicating with a candidate cell following a lower-layer cell mobility procedure, wherein the lower-layer cell mobility procedure comprises a cell switch from a source cell served by a first base station or a first centralized unit, CU, to a candidate cell served by a second base station or a second CU.
2. The method of embodiment 1, further comprising receiving, via lower-layer signalling from the first base station or the first CU, a command to switch to the candidate cell.
3. The method of embodiment 2, wherein the command comprises an indication that the candidate cell is served by a different CU or a different base station than the first base station or the first CU, or an instruction for the user equipment to refresh one or more security keys upon executing the lower-layer cell mobility procedure.
4. The method of any one of embodiments 2 to 3, wherein the lower-layer signalling comprises one or more of: L1 and L2 signalling.
5. The method of any one of embodiments 2 to 4, wherein the lower-layer signalling comprises one or more of: Medium Access Control, MAC, signalling and Physical, PHY, layer signalling.
6. The method of any one of embodiments 2 to 5, further comprising applying the configuration and transmitting, to the candidate cell, a message comprising an indication that the lower-layer cell mobility procedure is complete.
7. The method of any one of the preceding embodiments, wherein the configuration comprises at least a first part of information that enables the user equipment to refresh one or more security keys for use in connecting to and/or communicating with the candidate cell.
8. The method of any embodiment 7, wherein the first part of information that enables the user equipment to refresh one or more security keys comprises one or more of: an indication of a master key update parameter; an indication of one or more security algorithms to be used by the user equipment to derive one or more user plane keys and/or one or more control plane keys.
9. The method of any one of embodiments 7 to 8, wherein the one or more security keys comprise a master key for a network node serving the candidate cell.
10. The method of any one of embodiments 2 to 6, or embodiments 7 to 9 when dependent on embodiment 2, wherein the command comprises at least a second part of information that enables the user equipment to refresh one or more security keys for use in connecting to and/or communicating with the candidate cell.
11. The method of embodiment 10, wherein the second part of information comprises an indication of the configuration to be applied by the user equipment for connecting to and/or communicating with the candidate cell.
12. The method of any one of embodiments 7 to 11, when dependent on embodiment 6, wherein the message comprising an indication that the lower-layer cell mobility procedure is complete is transmitted using the refreshed one or more security keys.
13. The method of any one of embodiments 7 to 12, further comprising:
   upon executing the lower-layer cell mobility procedure to the candidate cell, using the information to determine one or more security keys; and
   using the one or more security keys to connect to and/or communicate with the candidate cell.
14. The method of any one of embodiments 7 to 12, further comprising:
   prior to executing the lower-layer cell mobility procedure to the candidate cell, using the information to determine one or more security keys; and
   upon executing the lower-layer cell mobility procedure, using the one or more security keys to connect to and/or communicate with the candidate cell.
15. The method of embodiment 14, wherein the user equipment uses the information to determine the one or more security keys upon reception of the configuration.
16. The method of any one of the preceding embodiments, wherein the configuration comprises one of: a full configuration; and a delta configuration defining one or more differences relative to a reference configuration.
17. The method according to any one of the preceding embodiments, wherein the lower-layer cell mobility procedure comprises an L1/L2 triggered mobility, LTM, procedure.
18. The method of any of the previous embodiments, further comprising:
   providing user data; and
   forwarding the user data to a host via the transmission to the network node.

### Group B Embodiments

19. A method performed by a network node, the method comprising:
   transmitting, to a user equipment, a configuration for use in connecting to and/or communicating with a candidate cell following a lower-layer cell mobility procedure.
20. The method of embodiment 19, wherein the configuration comprises a first part of information that enables the user equipment to refresh one or more security keys for use in connecting to and/or communicating with the candidate cell.
21. The method of embodiment 20, wherein the first part of information that enables the user equipment to refresh one or more security keys comprises one or more of: an indication of a master key update parameter; an indication of one or more security algorithms to be used by the user equipment to derive one or more user plane keys and/or one or more control plane keys.
22. The method of any one of embodiments 19 to 20, wherein the one or more security keys comprise a master key for a network node serving the candidate cell.
23. The method of any one of embodiments 20 to 22, wherein the configuration comprises an indication of one or more source cells, for use by the user equipment in determining whether to refresh the one or more security keys based on whether or not the lower-layer mobility procedure was from one of the one or more source cells.
24. The method of embodiment 23, wherein the indication of one or more source cells comprises one or more of: one or more cell IDs; one or more physical cell identifiers; one or more source cell configuration identifiers; and an identifier of a group of one or more cells.
25. The method of any one of embodiments 19 to 24, wherein the configuration comprises one of: a full configuration; and a delta configuration defining one or more differences relative to a reference configuration.
26. The method of any one of embodiments 19 to 25, wherein the network node comprises a first centralized unit, CU, or a first base station, and wherein the candidate cell is served by a second CU or a second base station.
27. The method of any one of embodiments 19 to 26, further comprising: transmitting, via lower-layer signalling to the user equipment, a command to switch to the candidate cell.
28. The method of embodiment 27, wherein the command comprises at least a second part of information that enables the user equipment to refresh one or more security keys for use in connecting to and/or communicating with the candidate cell.
29. The method of embodiment 28, wherein the second part of information comprises an indication of the configuration to be applied by the user equipment for connecting to and/or communicating with the candidate cell.
30. The method of any one of embodiments 27 to 29, wherein the command comprises an indication that the candidate cell is served by a different CU or a different base station than the source network node.
31. The method of any one of embodiments 27 to 30, wherein the lower-layer signalling comprises one or more of: L1 and L2 signalling.
32. The method of any one of embodiments 27 to 31, wherein the lower-layer signalling comprises one or more of: Medium Access Control, MAC, signalling and Physical, PHY, layer signalling.
33. The method according to any one of embodiments 19 to 32, wherein the lower-layer cell mobility procedure comprises an L1/L2 triggered mobility, LTM, procedure.
34. The method according to any one of embodiments 19 to 33, further comprising: transmitting a request message to a second network node, comprising a request for the second network node to transmit the configuration for use in connecting to and/or communicating with the candidate cell following the lower-layer cell mobility procedure.
35. The method according to embodiment 34, wherein the request message comprises a handover request message.
36. The method according to embodiment 34 or 35, wherein the request message comprises a request for the second network node to transmit a plurality of configurations for a plurality of candidate cells served by the second network node.
37. The method according to any one of embodiments 34 to 36, further comprising receiving, from the second network node, the configuration for use in connecting to and/or communicating with the candidate cell following the lower-layer cell mobility procedure.
38. The method of any of the previous embodiments, further comprising:
   obtaining user data; and
   forwarding the user data to a host or a user equipment.
39. A method performed by a second network node, the method comprising:
   receiving, from a user equipment, a message comprising an indication that a lower-layer cell mobility procedure from a first network node is complete.
40. The method of embodiment 39, wherein the message comprises an indication that the first network node is a different base station or a different CU than the second network node.
41. The method of embodiment 39 or 40, further comprising receiving, from the first network node, a request message comprising a request for the second network node to transmit a configuration for use by the user equipment in connecting to and/or communicating with a candidate cell served by the second network node following the lower-layer cell mobility procedure.
42. The method according to embodiment 41, wherein the request message comprises a request for the second network node to transmit a plurality of configurations for a plurality of candidate cells served by the second network node.
43. The method according to any one of embodiments 41 to 42, further comprising transmitting, to the first network node, the configuration for use in connecting to and/or communicating with the candidate cell following the lower-layer cell mobility procedure.

### Group C Embodiments

44. A method performed by a core network node, the method comprising:
   receiving, from a source network node or a target network node, an indication of a lower-layer cell mobility procedure for a user equipment from the source network node to the target network node, wherein the source network node and the target network node comprise different base stations or different centralized units.
45. The method of embodiment 44, further comprising, upon receiving the indication, performing a path switch for a connection of the user equipment, from a first data path between the core network and the source network node, to a second data path between the core network and the target network node.
46. The method of embodiment 44 or 45, wherein the indication is received from the source network node and further comprising transmitting, to the target network node, an indication of the lower-layer cell mobility procedure.
47. The method of embodiment 46, further comprising receiving a response from the target network node comprising dynamic information, and transmitting, to the source network node, the dynamic information.

### Group D Embodiments

48. A user equipment, comprising:
   processing circuitry configured to cause the user equipment to perform any of the steps of any of the Group A embodiments; and
   power supply circuitry configured to supply power to the processing circuitry.
49. A network node, the network node comprising:
   processing circuitry configured to cause the network node to perform any of the steps of any of the Group B embodiments;
   power supply circuitry configured to supply power to the processing circuitry.
50. A core network node, the network node comprising:
   processing circuitry configured to cause the network node to perform any of the steps of any of the Group C embodiments;
   power supply circuitry configured to supply power to the processing circuitry.
51. A user equipment (UE), the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
52. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
53. The host of the previous embodiment, wherein:
   the processing circuitry of the host is configured to execute a host application that provides the user data; and
   the UE comprises processing circuitry configured to execute a client application associated with the host application to receive the transmission of user data from the host.
54. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs any of the operations of any of the Group B embodiments to transmit the user data from the host to the UE.
55. The method of the previous embodiment, further comprising, at the network node, transmitting the user data provided by the host for the UE.
56. The method of any of the previous 2 embodiments, wherein the user data is provided at the host by executing a host application that interacts with a client application executing on the UE, the client application being associated with the host application.
57. A communication system configured to provide an over-the-top (OTT) service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
58. The communication system of the previous embodiment, further comprising:
   the network node; and/or
   the UE.
59. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
60. The host of the previous 2 embodiments, wherein:
   the processing circuitry of the host is configured to execute a host application that receives the user data; and
   the host application is configured to interact with a client application executing on the UE, the client application being associated with the host application.
61. The host of the any of the previous 2 embodiments, wherein the initiating receipt of the user data comprises requesting the user data.
62. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of the Group B embodiments to receive the user data from the UE for the host.
63. The method of the previous embodiment, further comprising at the network node, transmitting the received user data to the host.
64. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE), wherein the UE comprises a communication interface and processing circuitry, the communication interface and processing circuitry of the UE being configured to perform any of the operations of any of the Group A embodiments to receive the user data from the host.
65. The host of the previous embodiment, wherein the cellular network further includes a network node configured to communicate with the UE to transmit the user data to the UE from the host.
66. The host of the previous 2 embodiments, wherein:
   the processing circuitry of the host is configured to execute a host application, thereby providing the user data; and
   the host application is configured to interact with a client application executing on the UE, the client application being associated with the host application.
67. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs any of the operations of any of the Group A embodiments to receive the user data from the host.
68. The method of the previous embodiment, further comprising:
   at the host, executing a host application associated with a client application executing on the UE to receive the user data from the host application.
69. The method of the previous embodiment, further comprising:
   at the host, transmitting input data to the client application executing on the UE, the input data being provided by executing the host application,
   wherein the user data is provided by the client application in response to the input data from the host application.
70. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.
71. The host of the previous embodiment, wherein the cellular network further includes a network node configured to communicate with the UE to transmit the user data from the UE to the host.
72. The host of the previous 2 embodiments, wherein:
   the processing circuitry of the host is configured to execute a host application, thereby providing the user data; and
   the host application is configured to interact with a client application executing on the UE, the client application being associated with the host application.
73. A method implemented by a host configured to operate in a communication system that further includes a network node and a user equipment (UE), the method comprising:
   at the host, receiving user data transmitted to the host via the network node by the UE, wherein the UE performs any of the steps of any of the Group A embodiments to transmit the user data to the host.
74. The method of the previous embodiment, further comprising:
   at the host, executing a host application associated with a client application executing on the UE to receive the user data from the UE.
75. The method of the previous 2 embodiments, further comprising:
   at the host, transmitting input data to the client application executing on the UE, the input data being provided by executing the host application,
      wherein the user data is provided by the client application in response to the input data from the host application.

1-39. (canceled)

40. A method performed by a user equipment, the method comprising:
receiving, from a network node, a configuration for use in connecting to and/or communicating with a candidate cell following a lower-layer cell mobility procedure, wherein the lower-layer cell mobility procedure comprises a cell switch from a source cell served by a first base station or a first centralized unit (CU) to a candidate cell served by a second base station or a second CU, and wherein the configuration comprises at least a first part of information that enables the user equipment to refresh one or more security keys for use in connecting to and/or communicating with the candidate cell.

41. The method of claim 40, further comprising receiving, via lower-layer signalling from the first base station or the first CU, a command to switch to the candidate cell.

42. The method of claim 41, wherein the command comprises an indication that the candidate cell is served by a different CU or a different base station than the first base station or the first CU, or an instruction for the user equipment to refresh one or more security keys upon executing the lower-layer cell mobility procedure.

43. The method of claim 41, wherein the command comprises at least a second part of information that enables the user equipment to refresh one or more security keys for use in connecting to and/or communicating with the candidate cell.

44. The method of claim 43, wherein the second part of information comprises an indication of the configuration to be applied by the user equipment for connecting to and/or communicating with the candidate cell.

45. The method of claim 41, further comprising applying the configuration and transmitting, to the candidate cell, a message comprising an indication that the lower-layer cell mobility procedure is complete.

46. The method of claim 45, wherein the message comprises an indication that the lower-layer cell mobility procedure is complete is transmitted using the refreshed one or more security keys.

47. The method of claim 40, wherein the first part of information that enables the user equipment to refresh one or more security keys comprises one or more of: an indication of a master key update parameter; an indication of one or more security algorithms to be used by the user equipment to derive one or more user plane keys and/or one or more control plane keys.

48. The method of claim 40, wherein the one or more security keys comprise a master key for a network node serving the candidate cell.

49. The method of claim 40, further comprising:
upon executing the lower-layer cell mobility procedure to the candidate cell, using the information to determine one or more security keys; and
using the one or more security keys to connect to and/or communicate with the candidate cell.

50. The method according to claim 40, wherein the lower-layer cell mobility procedure comprises an L1/L2 triggered mobility (LTM) procedure.

51. A method performed by a network node, the method comprising:
transmitting, to a user equipment, a configuration for use in connecting to and/or communicating with a candidate cell following a lower-layer cell mobility procedure, wherein the configuration comprises a first part of information that enables the user equipment to refresh one or more security keys for use in connecting to and/or communicating with the candidate cell.

52. The method of claim 51, wherein the first part of information that enables the user equipment to refresh one or more security keys comprises one or more of: an indication of a master key update parameter; an indication of one or more security algorithms to be used by the user equipment to derive one or more user plane keys and/or one or more control plane keys.

53. The method of claim 51, wherein the one or more security keys comprise a master key for a network node serving the candidate cell.

54. The method of claim 51, wherein the configuration comprises an indication of one or more source cells, for use by the user equipment in determining whether to refresh the one or more security keys based on whether or not the lower-layer mobility procedure was from one of the one or more source cells.

55. The method of claim 51, wherein the network node comprises a first centralized unit (CU) or a first base station, and wherein the candidate cell is served by a second CU or a second base station.

56. A user equipment configured for operation in a communications network, the user equipment comprising:
a communication interface; and
processing circuitry configured to receive a configuration for the user equipment via the communication interface, the configuration sent from a network node of the communications network for use by the user equipment in connecting to and/or communicating with a candidate cell following a lower-layer cell mobility procedure, wherein the lower-layer cell mobility procedure comprises a cell switch from a source cell served by a first base station or a first centralized unit (CU) to a candidate cell served by a second base station or a second CU, wherein the configuration comprises at least a first part of information that enables the user equipment to refresh one or more security keys for use in connecting to and/or communicating with the candidate cell.

57. A network node configured for operation in a communications network, the network node comprising:
processing circuitry configured to cause the network node to transmit, to a user equipment, a configuration for use in connecting to and/or communicating with a candidate cell following a lower-layer cell mobility procedure, wherein the configuration comprises a first part of information that enables the user equipment to refresh one or more security keys for use in connecting to and/or communicating with the candidate cell.
